(19) United States
(12) Patent Application Publication
(10) Pub. No.: US 2026/0206699 A1
(43) Pub. Date: Jul. 23, 2026

(54) THREE STAGE INDOOR VERTICAL FARMING SYSTEMS AND METHODS FOR SPROUTING SEED TO GROW FODDER FOR LIVESTOCK OR MICROGREENS FOR HUMAN CONSUMPTION

(71) Applicant: Paul PLUSS, Ramona, CA (US)

(72) Inventor: Paul PLUSS, Ramona, CA (US)

(21) Appl. No.: 19/138,448

(22) PCT Filed: Dec. 13, 2023
(86) PCT No.: PCT/US2023/083823

§ 371 Date: Jun. 12, 2025

Related U.S. Application Data
(60) Provisional application No. 63/432,277, filed on Dec. 13, 2022.

(51) Int. Cl. A01G 31/06; A01G 31/02; A01G 31/04

(52) U.S. Cl. CPC A01G 31/06; A01G 31/024; A01G 31/042

(57) ABSTRACT

A method of growing fodder is described, which includes a first, second, and third stage. The first stage includes watering seeds in a tray with a grow solution. The first stage also includes a reservoir configured to hold the grow solution and the tray. The watering at the first stage is sufficient for the seeds to absorb the grow solution and allow first roots to form. The tray is then moved to the second stage by placing the tray in a first tray rack and watering the tray an amount sufficient for stems and first leaves to develop from the seeds thereby forming seedlings. The tray is then moved to the third stage by placing the tray in a second tray rack, where the tray is watered and exposed to lighting such that the seedlings mature into grown fodder. The tray is then removed from the second tray rack.

### CROSS-REFERENCE TO RELATED PATENT APPLICATION

This application claims the benefit of U.S. Provisional Ser. No. 63/432,277, filed Dec. 13, 2022, the entire contents of which is hereby incorporated by reference in its entirety.

### FIELD OF THE DISCLOSURE

The present disclosure generally relates to indoor farming and more particularly to indoor vertical farming systems and methods for sprouting seeds and growing fodder and/or microgreens from those seeds.

### BACKGROUND

Indoor farming systems may be used to grow various types of plants indoors. Different indoor growing systems may include soil for growing plants, for example, in greenhouses. Other systems may be hydroponic, where water or liquid is used instead of soil for growing plants indoors. Indoor farming systems may also use indoor lighting to provide light to plants that are being grown.

### SUMMARY

An illustrative method of growing fodder includes placing seeds in a tray and moving the tray to a first stage of a fodder growing system. The first stage includes a reservoir configured to hold a grow solution and the tray. The reservoir includes an open top side and is configured to hold the tray over the open top side of the reservoir. The method further includes watering the seeds in the tray with the grow solution at first designated intervals within a first predetermined amount of time while the tray is at the first stage. The watering at the first stage is sufficient for the seeds to absorb the grow solution and allow first roots to form. The method further includes moving the tray from the first stage to a second stage of the fodder growing system. The moving the tray from the first stage to the second stage includes placing the tray in a first tray rack. The method further includes watering the seeds, with the grow solution from the reservoir, in the tray in the first tray rack at second designated intervals within a second predetermined amount of time while the tray is in the second stage. The second predetermined amount of time is sufficient for stems and first leaves to develop from the seeds thereby forming seedlings. The method further includes moving the tray from the second stage to a third stage of the fodder growing system. The moving the tray from the second stage to the third stage includes placing the tray in a second tray rack. The method further includes watering the seedlings, with the grow solution from the reservoir, in the tray in the second tray rack at third designated intervals within a third predetermined amount of time while the tray is in the third stage. The method further includes exposing the seedlings in the second tray rack to light while the tray is in the third stage. The tray remains in the third stage for the third predetermined amount of time sufficient for the seedlings to mature into grown fodder. The method further includes removing the tray from the second tray rack upon completion of the third predetermined amount of time.

In an embodiment, the first tray rack includes a first plurality of shelves configured to store a first plurality of trays, the second tray rack includes a second plurality of shelves configured to store a second plurality of trays, and a first spacing between each of the first plurality of shelves is less than a second spacing between each of the second plurality of shelves.

In an embodiment, the first spacing is sufficient for forming seedlings from respective seeds in each of the first plurality of trays.

In an embodiment, the second spacing is sufficient for maturing the seedlings in each of the second plurality of trays into grown fodder.

In an embodiment, at least one of the first tray rack or the second tray rack includes casters mounted to a bottom of the at least one of the first tray rack or the second tray rack.

In an embodiment, the tray is moved to the first stage after the seeds are placed in the tray.

In an embodiment, the seeds are placed in the tray after the tray is moved to the first stage.

In an embodiment, the tray is a first tray, and the moving of the first tray to the first stage includes placing the first tray on top of a second tray.

In an embodiment, the first tray includes holes in a bottom of the first tray.

In an embodiment, during the watering of the seeds in the tray while the tray is at the first stage, the holes in the bottom of the first tray are configured to permit excess grow solution to drain from the first tray into the second tray.

In an embodiment, the first tray at least partially nests within the second tray after the first tray is placed on top of the second tray.

In an embodiment, during the watering of the seeds in the tray while the tray is at the first stage, excess grow solution drains from the tray to the reservoir.

In an embodiment, the excess grow solution drains through holes in a bottom of the tray.

In an embodiment, the grow solution used in the watering of the seeds in the tray while the tray is at the first stage is pumped from the reservoir and a pump that pumps the grow solution from the reservoir to the tray is controlled by a computing device to water the tray at the first stage at the first designated intervals within the first predetermined amount of time.

In an embodiment, the grow solution used in the watering of the tray in the first tray rack while the tray is in the second stage is pumped from the reservoir and a pump that pumps the grow solution from the reservoir to the tray is controlled by a computing device to water the tray at the second stage at the second designated intervals within the second predetermined amount of time.

In an embodiment, the grow solution used in the watering of the tray in the second tray rack while the tray is in the third stage is pumped from the reservoir and a pump that pumps the grow solution from the reservoir to the tray is controlled by a computing device to water the tray at the third stage at the third designated intervals within the third predetermined amount of time.

In an embodiment, the seeds placed in the tray are dry seeds.

In an embodiment, the tray is a first tray, and the method further includes removing a second tray from the second tray rack prior to placing the first tray in the second tray rack.

In an embodiment, placing the first tray in the second tray rack causes at least one third tray to move within the second tray rack.

In an embodiment, the second tray rack includes rollers built into the shelves of the second tray rack, and the at least one third tray moves within the second tray rack along the rollers.

In an embodiment, the placing of the first tray in the second tray rack pushes the at least one third tray along the rollers.

In an embodiment, the exposing of the seedlings in the second tray rack to the light includes applying grow lighting to the tray while the tray is in the second tray rack in the third stage.

In an embodiment, grow lighting is not applied to the tray while the tray is in the first tray rack in the second stage or while the tray is in the first stage.

An illustrative system for growing fodder includes at least one pump and a first stage including a reservoir and first piping. The reservoir is configured to hold grow solution, the reservoir includes an open top side, and a stack of trays are configured to rest over the open top side of the reservoir. The first piping fluidly connects the reservoir to an area at or above the open top side of the reservoir. While the stack of trays is placed over the open top side of the reservoir, the at least one pump is configured to pump the grow solution from the reservoir into a top tray of the stack of trays. The system further includes a second stage including a first tray rack and second piping. The first tray rack includes a first plurality of shelves, and each of the first plurality of shelves is configured to receive one of a plurality of trays. The second piping fluidly connects the reservoir to an area at or above a top of the first tray rack. The at least one pump is configured to pump the grow solution from the reservoir to the area at or above the top of the first tray rack. The system further includes a third stage including a second tray rack and third piping. The second tray rack includes a second plurality of shelves, and each of the second plurality of shelves is configured to receive one or more of the plurality of trays. The third piping fluidly connects the reservoir to an area at or above a top of the second tray rack. The at least one pump is configured to pump the grow solution from the reservoir to the area at or above the top of the second tray rack. The third stage further includes at least one light source positioned above each of the second plurality of shelves.

In an embodiment, a plurality of stacks of trays is configured to rest over the open top side of the reservoir.

In an embodiment, the at least one pump is configured to pump the grow solution from the reservoir into a top tray of each of the plurality of stack of trays.

In an embodiment, each of the trays in the stack of trays includes holes in the bottom of each of the trays. While the stack of trays is placed over the open top side of the reservoir and the at least one pump pumps the grow solution through the first piping, at least some of the grow solution drains through the stack of trays through the holes and back into the reservoir.

In an embodiment, each tray except a bottom tray of the stack of trays is configured to at least partially nest within a subsequent tray below each tray in the stack of trays.

In an embodiment, the at least one pump is configured to pump the grow solution from the reservoir through the second piping and into a top tray in the first tray rack.

In an embodiment, each tray in the first tray rack includes holes in the bottom of each of the trays in the first tray rack. While the at least one pump pumps the grow solution through the second piping, at least some of the grow solution drains through the trays in the first tray rack and into a drain reservoir.

In an embodiment, the system includes a sump pump configured to pump the grow solution from the drain reservoir into the reservoir via fourth piping.

In an embodiment, the at least one pump is configured to pump the grow solution from the reservoir through the third piping and into a top tray in the second tray rack.

In an embodiment, each tray in the second tray rack includes holes in the bottom of each of the trays in the second tray rack. While the at least one pump pumps the grow solution through the third piping, at least some of the grow solution drains through the trays in the second tray rack and into a drain reservoir.

In an embodiment, the system includes a sump pump configured to pump the grow solution from the drain reservoir into the reservoir via fourth piping.

In an embodiment, each of the second plurality of shelves are configured to receive more than one tray of the plurality of trays.

In an embodiment, each of the second plurality of shelves includes rollers configured to permit the more than one tray of the plurality of trays to roll or slide along a respective shelf of the second plurality of shelves.

In an embodiment, at least one of the reservoir, the first tray rack, or the second tray rack includes casters mounted thereon.

In an embodiment, the system includes valves in fluid connection with one or more of the first piping, the second piping, or the third piping. The valves are controllable to cause the at least one pump to selectively pump the grow solution through only one or two of, but not all of, the first piping, second piping, or third piping at a time.

In an embodiment, the at least one light source includes at least one string of light emitting diodes (LEDs).

In an embodiment, the system includes at least one solar panel configured to power the at least one light source.

In an embodiment, the at least one solar panel generates direct current power, the at least one light source is powered by direct current, and the at least one solar panel is electrically connected to the at least one light source so that whenever the at least one solar panel is generating the direct current power the at least one light source is powered with the direct current power.

In an embodiment, the grow solution includes water.

In an embodiment, the grow solution further includes hydrogen peroxide.

In an embodiment, the grow solution includes plant fertilizer.

In an embodiment, the grow solution includes at least one mineral.

In an embodiment, a first spacing between each of the first plurality of shelves is less than a second spacing between each of the second plurality of shelves.

In an embodiment, the first spacing is sufficient for forming seedlings from respective seeds in each of the first plurality of trays.

In an embodiment, the second spacing is sufficient for maturing the seedlings in each of the second plurality of trays into grown fodder.

An illustrative non-transitory computer-readable medium having instructions stored thereon that, upon execution by a computing device, cause a system to perform operations including sending a first set of valve control signals configured to cause a set of valves to permit grow solution to be pumped through a piping system from a reservoir of a fodder growing system to a first tray at a first stage of the fodder growing system. The operations further include, after sending the first set of valve control signals, sending a first pump control signal to a pump. The first pump control signal is configured to cause the pump to water seeds in the first tray at the first stage of the fodder growing system. The operations further include sending a second set of valve control signals configured to cause the set of valves to permit the grow solution to be pumped through the piping system from the reservoir to a second tray at a second stage of the fodder growing system. The operations further include, after sending the second set of valve control signals, sending a second pump control signal to the pump. The second pump control signal is configured to cause the pump to water the second tray at the second stage of the fodder growing system. The operations further include sending a third set of valve control signals configured to cause the set of valves to permit the grow solution to be pumped through the piping system from the reservoir to a third tray at a third stage of the fodder growing system. The operations further include after sending the third set of valve control signals, sending a third pump control signal to the pump, wherein the third pump control signal is configured to cause the pump to water the third tray at the third stage of the fodder growing system.

In an embodiment, the first set of valve control signals, the first pump control signal, the second set of valve control signals, the second pump control signal, the third set of valve control signals, and the third pump control signal are configured to be sent according to a predetermined schedule. The predetermined scheduled defines designated intervals during a predetermined amount of time during which the first tray is watered at the first stage, the second tray is watered at the second stage, and the third tray is watered at the third stage.

In an embodiment, none of the first tray, the second tray, and the third tray are watered at the same time.

In an embodiment, the predetermined schedule is user definable via user inputs entered at a user interface.

In an embodiment, the instructions further cause the system to perform operations including controlling a light source to provide light to the third tray at the third stage.

In an embodiment, the controlling of the light source includes sending a lighting control signal configured to cause the light source to be powered by one of a battery power source, a building alternating current (AC) source, a solar panel direct current (DC) source, or a generator.

In an embodiment, the lighting control signal is sent to cause the light source to be powered according to a predetermined schedule. The predetermined scheduled defines designated intervals during a predetermined amount of time during which grow lighting is provided to the third tray at the third stage.

In an embodiment, the predetermined schedule is user definable via user inputs entered at a user interface.

### BRIEF DESCRIPTION OF THE DRAWINGS

FIG. 1 is a perspective view of an example three stage fodder growing system in accordance with various embodiments.

FIG. 2 is a perspective view of an example first stage of a three stage fodder growing system in accordance with various embodiments.

FIG. 3 is a perspective view of an example diffuser in a fodder growing tray in accordance with various embodiments.

FIG. 4 is a perspective view of an example second stage of a three stage fodder growing system in accordance with various embodiments.

FIG. 5 is a perspective view of an example third stage of a three stage fodder growing system in accordance with various embodiments.

FIG. 6 is a perspective view of an example third stage of a three stage fodder growing system with fodder growing trays containing seedlings in the process of maturing into grown fodder in accordance with various embodiments.

FIG. 7 is a perspective view of a sump pump and grow solution drain for a fodder growing system in accordance with various embodiments.

FIG. 8 is a partial perspective view of an example rack for mounting grow lighting for a third stage of a fodder growing system in accordance with various embodiments.

FIG. 9 is a partial perspective view of an example portion of a third stage of a fodder growing system where the fodder is being watered in accordance with various embodiments.

FIG. 10 is a diagrammatic view of an example control system for a three stage fodder growing system in accordance with various embodiments.

FIG. 11 is a flow chart illustrating an example method for using a three stage fodder growing system in accordance with various embodiments.

FIG. 12 is a flow chart illustrating an example method for electronically controlling a three stage fodder growing system in accordance with various embodiments.

FIG. 13 is a diagrammatic view of an example floor plan and conveyer system for implementing a plurality of three stage fodder growing systems in accordance with various embodiments.

FIG. 14 is a cross-sectional partial front view of two stacked trays for use in a fodder growing system in accordance with various embodiments.

FIG. 15 is a partial top plan view of a bottom of a tray for use in a fodder growing system in accordance with various embodiments.

FIG. 16 is a cross-sectional front view of an example diffuser in a fodder growing tray in accordance with various embodiments.

FIG. 17 is a top plan view of the example diffuser of FIG. 16 in accordance with various embodiments.

FIG. 18 is a perspective view of an axle for a roller of a tray rack of a third stage in accordance with various embodiments.

FIG. 19 is a perspective view of a fitting for connecting to the axle of FIG. 18 in accordance with various embodiments.

FIG. 20 is a diagrammatic view of an example user interface for a computing device for use with a fodder growing system in accordance with various embodiments.

FIG. 21 is a diagrammatic view of an example of a computing environment in accordance with various embodiments.

### DETAILED DESCRIPTION

The following disclosure of example methods and apparatus is not intended to limit the scope of the detailed description to the precise form or forms detailed herein. Instead, the following disclosure is intended to be illustrative so that others may follow its teachings.

Described herein are systems and methods for sprouting and growing seeds using, for example, hydroponic growing methods. Seeds such as barley, wheat, oats, sorghum, corn, or legumes (e.g., alfalfa, clover, cow peas, or horse gram) may be grown into a thick mass of roots and grass for feeding livestock. Other types of seeds such as vegetable microgreens (e.g., pea, arugula, amaranth, basil, beet, broccoli, cabbage, celery, chia, chicory, cilantro, collard green, dill, endive, fennel, leek, lettuce, kale, kohlrabi, mint, mung bean, mustard, parsley, radish, red cabbage, sorrel, spinach, Swiss chard, sunflower, thyme, watercress, or wheatgrass) may also be grown using the systems and methods described herein, and may be used for human consumption. As used herein, fodder may refer to any type of seed that is grown using the systems and methods described herein, including microgreens. A thick mass of roots and greens (e.g., stems or leaves) may be grown in trays without the use of dirt, such that the thick mass of roots and greens can easily be removed from its growing tray in one piece that is tightly held together by its dense root structure. When removed, the thick mass of roots and greens may be referred to as a biscuit of fodder that is fully consumable by most any form of livestock (e.g., cattle, hogs/swine, sheep, or goats) as well as foul (e.g., chickens, ducks, or turkeys) and horses.

The various systems and methods herein include ways of growing fodder for livestock, for example, with indoor vertical farming as opposed to traditional ways of farming hay and other forage crops for livestock. The systems and methods herein may advantageously reduce the acreage of dirt farming needed, may reduce the usage of tractors that consume large amounts of diesel fuel (and thereby reduce fuel usage and emissions output as a byproduct of that fuel usage), may lead to a significant reduction of farming irrigation water used, and/or may reduce the overall cost for feeding livestock.

The systems and methods described herein advantageously include three stages in its growing process. The first stage may be referred to herein as a presoak germinating stage. The second stage may be referred to herein as an early sprouting and starting of the root mass (and this stage may be performed without the use of grow lighting). The third stage may be referred to herein as the greening stage where more room is added vertically to grow the fodder, and at this stage the fodder may receive artificial grow lighting.

Using the grow lighting for only the final stage (e.g., exposing the trays to grow lighting only a subset of the days or total time in which the fodder is grown) may reduce the electricity used and costs associated with the electricity used as compared to other grow systems. The three stage methods and systems described herein may also advantageously increase the density of a growing area in a building, allowing for more stacking of trays vertically to maximize a harvest output for a given amount of square footage of floor space. The three stages further advantageously may treat the seeds in a similar way to how it would grow in nature, increasing the efficacy and efficiency of the system, reducing the amount of seeds needed to grow a given volume of fodder compared to other systems, and reducing the amount of resources (e.g., electricity or water) used to grow a given volume of fodder compared to other systems.

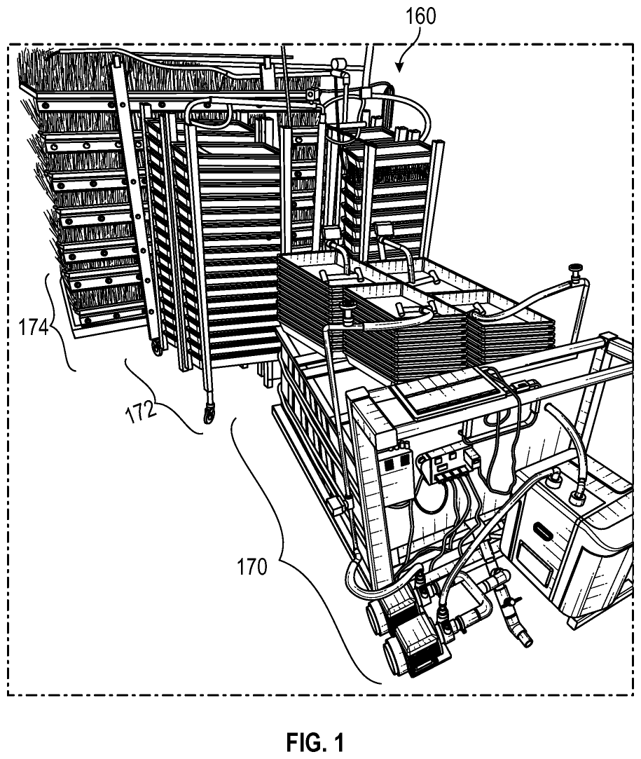

FIG. 1 is a perspective view of an example three stage fodder growing system 160 in accordance with various embodiments. In a first stage 170, trays full of seeds are stacked on top of a reservoir of grow solution. The grow solution may be pumped into the trays so that the seeds are watered and sprout first roots. The trays may then be moved to a second stage 172, where the trays are put into tray racks so the seeds have more room to grow and sprout into seedlings that begin growing more roots, as well as stems and/or leaves. During the second stage, the seeds/seedlings may be watered, but may not be exposed to grow lighting. Advantageously, the seeds, seedlings, fodder, etc. do not need to be switched between trays or vessels during the process after seeds (e.g., dry seeds) have been initially added to a tray and placed at stage one. Instead, only the trays are moved and the seeds/plants do not need to be removed from the trays until they are a fully grown fodder biscuit.

In a third stage 174, the trays are moved to another tray rack that provides even more space/room for the seedlings to grow into mature fodder. At the third stage, the seedlings/fodder are exposed to grow lighting and watered. As such, the three stage fodder system 160 may be advantageously used to grow mature fodder as described herein. By using grow lighting only in the final stage, total power/electricity consumed may be reduced compared to other indoor farming systems, thereby also reducing costs to grow fodder using the system 160.

Each of the portions of the fodder growing system 160 (e.g., the reservoir of the first stage 170, the tray racks of the second stage 172, and/or the tray racks of the third stage 174) may have casters attached to them. In this way, the components of the stages may be easily moved for cleaning of the floor, combining with other fodder systems, or any other reason as desired.

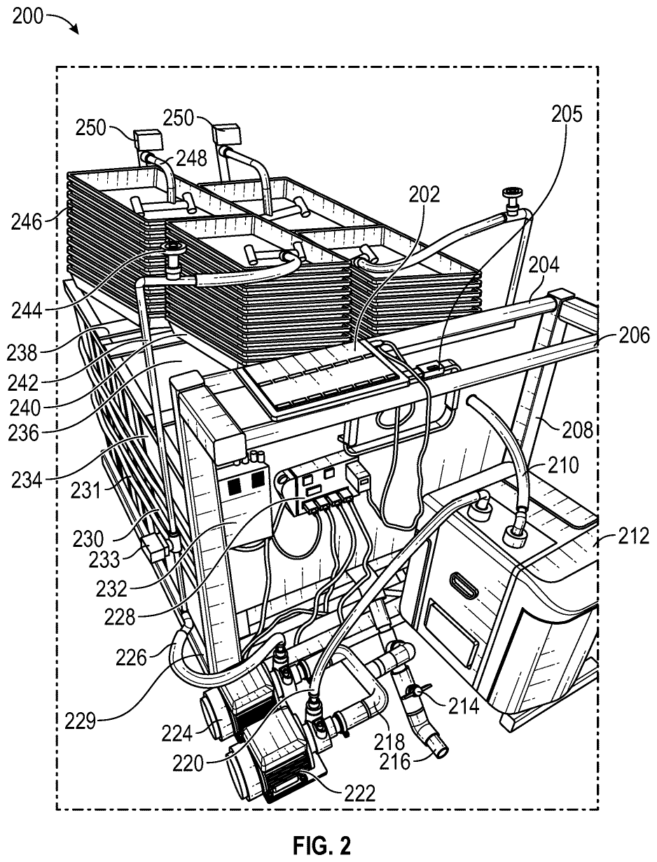

FIG. 2 is a perspective view of an example first stage 200 of a three stage fodder growing system in accordance with various embodiments. The first stage 200 in FIG. 2 may be similar to, for example, the first stage 170 in the fodder growing system 160 of FIG. 1.

The first stage 200 combines several components together to advantageously maximize space efficiency. A base 204 of the first stage 200 is a steel framed cart that may be on casters (not shown in FIG. 2) so that the base 204 may be easily moved around on the casters. The base 204 may include a handle so that the base 204 and everything on it may be easily pushed around using the handle. The base 204 includes a vertical support 208 that connects to a horizontal support 229. The base 204, including the vertical support 208 and the horizontal support 229 are configured to support a frame 230, such that the vertical support 208, the horizontal support 229, and the frame 230 together provide support for a reservoir 234 of grow solution. The vertical support 208, the horizontal support 229, and the frame 230 may all be made from metal such as steel, for example, and the reservoir 234 may be made from a plastic or metal, for example.

The grow solution in the reservoir 234 may be made up of water that is mixed with various materials such as any combination of water soluble plant fertilizer(s), mineral(s), hydrogen peroxide, etc. As such, the grow solution used in the fodder growing system described herein may provide nutrients plants use to grow (e.g., to maturity), which is advantageous compared to some fodder systems that use just tap water. Various types of minerals and/or fertilizers that may be used/dissolved in a grow solution may include any combination of nitrogen, phosphorous, and/or potassium.

Hydrogen peroxide may be mixed into the grow solution in various embodiments. For example, a timer of a computing device and a metering pump may be used to slowly add hydrogen peroxide to the reservoir (e.g., at the top of the reservoir, at the bottom of the reservoir through a tube or piping) gradually while the fodder growing system is in use. The hydrogen peroxide may, for example, help keep the system clean and free from bacteria or other contaminants.

In various embodiments, a reservoir may also be a sterile reservoir or a biological reservoir. In a sterile reservoir embodiment, the grow solution may be generally free of (or at least it is desired for the grow solution to be as free as possible from) living organisms, such as bacteria, fungi, etc. A sterile reservoir may be used in various embodiments where more control over a growing environment is desired. The grow solution for a sterile reservoir may be sterilized in various ways in various embodiments. For example, the grow solution for a sterile reservoir may be sterilized through the use of one or more of chemicals mixed into the grow solution, exposing the grow solution to ultraviolet (UV) light, and/or applying heat to the grow solution. A biological reservoir may have living organisms within the grow solution, such as beneficial bacteria, fungi, etc. Such organisms may help break down organic matter in the grow solution and convert it into nutrients that may be absorbed by the seeds, seedlings, or fodder of various embodiments described herein. Biological reservoirs may include grow solutions that use organic fertilizers and/or compost teas. In various embodiments, biological or sterile grow solutions/reservoirs may be used. For example, a biological reservoir may be used where it is desirable to grow fodder for use in feeding animals that will be marketed as or certified as organically raised animals.

In various embodiments, however, tap water without added fertilizer, minerals, hydrogen peroxide, etc. may be used as the grow solution for one or more of the first stage 170, second stage 172, or third stage 174 of the fodder grow system. In various embodiments, the grow solution for the first stage 170 uses tap water for the grow solution. In various embodiments, the grow solution for the second stage 172 uses tap water for the grow solution. In various embodiments, the grow solution for the third stage 174 uses tap water for the grow solution. In various embodiments, the fodder grow system 170 uses a combination of tap water and water with that is mixed with various materials as described herein for the grow solution. For example, in various embodiments, the first stage 170 uses tap water for the grow solution, whereas the grow solution for the second stage 172 and the third stage 174 includes water mixed with various materials as described herein.

The first stage 200 further includes electronics, plumbing, electric valves, a computer with custom designed timers for each stage, and circulating pump(s) as will be described herein below.

A drainpipe 216 may be connected to the reservoir 234 so that the grow solution in the reservoir 234 may be drained if desired by turning a valve 214. Ordinarily, the valve 214 will be closed so that the reservoir does not drain grow solution out of the drainpipe 216. The drainpipe 216 is further connected to a pipe 218 such that grow solution may be supplied to a pump 222 and a pump 224. The pump 222 may pump grow solution as desired through a pipe 220 to a chiller 212. The chiller 212 may cool the grow solution to a desired temperature and return chilled grow solution back into the reservoir 234 through a pipe 210. In various embodiments, a chiller may not be used where, for example, a room or building where the fodder growing system is climate controlled, and the grow solution may therefore be maintained at a desired temperature via climate control of the space. In such embodiments, the second pump 222 may also be omitted from the system, such that the single pump 224 may used for the fodder growing system.

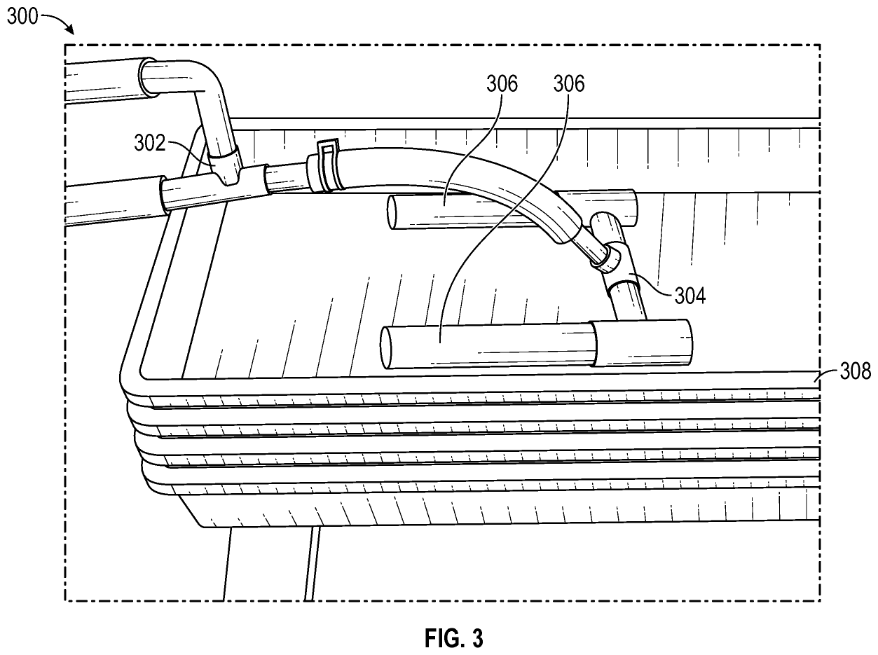

The pump 224 may pump grow solution from the reservoir through a pipe 226. The pipe 226 may be fluidly connected with a pipe 242 by an electronically controlled valve 233. In this way, a computing device such as a computing device 202 may control the valve 233 to control when grow solution is pumped into the pipe 242 and subsequently into a first stack of trays 240. Valve 244 may be a gate valve that slows down the flow of water through the pipe 242 to prevent too much water entering the stack of trays 246. In various embodiments, gate valves or other valves to slow down or otherwise inhibit water flow through the pipes may not be used. For example, various water diffusers are shown and described herein with respect to FIGS. 3, 16, and 17 that may be used in lieu of gate valves to slow down water flow. In various embodiments no valves or diffusers may be used to slow down water. The pipe 226 may also be fluidly connected to a pipe 231 that runs to other electronically controlled valves for the other stacks of trays shown in FIG. 2 (e.g., to an electronically controlled valve 250 that controls the grow solution flowing into pipe 248 for a stack of trays 246). In FIG. 2, there are a total of four stacks of trays and four accompanying pipes that may all have electronically controlled valves associated therewith (although only three electronically controlled valves are visible in FIG. 2). In this way, the computing device 202 may control when and how each of the stacks of trays are watered by controlling the pump 224 and the electronically controlled valves (e.g., the valves 233 and 250). The valves may, in various embodiments, be ball valves. Ball valves may be advantageous because the grow solution may have seeds or other plant matter that gets washed or drained into the reservoir. The ball valves advantageously will not clog even if a seed or other matter is passing through the hosing. For example, the seeds or other plant matter may just be pumped through the ball valves and hosing/piping back into a tray of the fodder growing system.

The pipe 231 may also connect to further piping that provides grow solution from the reservoir 234 to other stages (e.g., a second stage and a third stage) of a fodder growing system. In this way, only a single pump may be used to distribute grow solution to all three stages of a fodder growing system. Electrically controlled valves at each stage may be controlled so that only a desired stage or portion of a stage receives the grow solution from the reservoir 234 at any given time while the pump 224 is on and pumping. As such, the pump may be sized so that it does not require a large amount of power or pumping capacity as the valves may be used to control what is watered and when within a three stage fodder growing system. That is, the pump 224 may run to pump grow solution to different portions or stages of a three stage fodder growing system as described herein at different times throughout a day rather than using a large pump to provide grow solution to all or many stages/portions of a fodder growing system at once.

Stated another way, the fodder growing systems and methods described herein include valves in fluid connection with one or more of a first piping associated with a first stage, a second piping associated with a second stage, and/or a third piping associated with a second stage, such that the valves are controllable to cause at least one pump to selectively pump grow solution a single one of the stages, two of the three stages, or all three of the stages at once as desired. In this way, grow solution may be pumped to only one or two of, but not all of, the first piping (and thereby the first stage), second piping (and thereby the second stage), or the third piping (and thereby the third stage) at a time, or may be pumped to all three piping systems and their associated stages at once. In addition, since each stage may have more than one valve, the system may also be controlled to only pump grow solution to a given part of a stage at once. For example, as shown in FIG. 2, there may be four stacks of trays, and each stack of tray may have separate piping associated with a valve to control the grow solution pumped to each stack of trays. As such, not only can valves be used to control grow solution being pumped to each stage, but valves may also be used to control how grow solution is pumped to each portion of a stage such that some or all portions of a given stage may have grow solution pumped to it at any given time by controlling the valves with a computing device such as the computing device 202 in FIG. 2. Similarly, the computing device 202 may be used to control the valves in other stages. For example, where there is more than one tray rack in the second stage or more than one tray rack in the third stage, the computing device 202 may be used to control valves and/or lighting of the more than one tray rack in the second stage or more than one tray rack in the third stage. In each instance, each tray rack in the second or third stages may have a valve for controlling the pumping of grow solution to each individual tray rack, even where there are multiple tray racks in a given stage as described herein in various embodiments. In various embodiments, the pump may be of different sizes. For example, a pump used to move the grow solution to the different stages may be a 350 watt water pump. By varying when different stages are watered, the pump may not run all the time. For example, the pump may run anywhere from 10% or less to 75% or less of the time that the fodder growing system is in use (e.g., 10% or less of the time, 15% or less of the time, 20% or less of the time, 25% or less of the time, 30% or less of the time, 35% or less of the time, 40% or less of the time, 45% or less of the time, 50% or less of the time, 55% or less of the time, 60% or less of the time, 65% or less of the time, 70% or less of the time, or 75% or less of the time).

The base 204 also includes a power strip 228 for distributing power to various components of the fodder growing system, such as the computing device 202, the pumps 222 and 224, the chiller 212, transformer 232, etc. The power strip 228 may be connected to alternating current (AC) power supplied by a building in which the fodder growing system is located, for example. In various embodiments, a transformer such as the transformer 232 may be used in the event that various components of the system do not use the same voltage of AC power provided by a system or building power. For example, typical AC power provided by building power in the United States is 120 Volt (V) or 240 V power. Various components of the fodder growing system may operate at 12 V direct current (DC), 48 V DC, or other voltages. For example, the transformer 232 may be used to transform AC power from 120 or 240 V power to 12 V DC or 48 V DC power used by grow lighting, valves, pumps, etc. in the fodder growing system. Other voltages, transformers, etc. may be used based on the type of equipment used in the system and the voltage(s) that such equipment operates at.

A box 205 may be a water-tight box configured to store or have mounted therein other electronic components of a system. For example, the box 205 may include a switching circuit board connected to the computing device 202. The switching circuit board may be made up of switches for controlling valves of the system so that the computing device 202 may control how water is circulated to different portions of the system as described herein. For example, each valve may have its own electronic switch in the box 205 by which each valve is controlled by the computing device 202. Other switches may also be in the box 205, such as switches for controlling the pump 224, a pump that adds hydrogen peroxide to the reservoir 236. A solid state relay may also be used in various embodiments in conjunction with the control of the pump 224 to prevent the switch in the box 205 from burning out. In various embodiments, additional or fewer components than those described herein may be used or mounted in the box 205 as needed or desired for the equipment used in a given fodder growing system.

A removable rack 238 is placed over an open top side 236 of the reservoir 234. The removable rack 238 is configured such that four stacks of trays (e.g., the stacks of trays 240 and 246) may be placed over the open top side 236 of the reservoir 234. The individual trays in the stacks of trays (e.g., the stacks of trays 240 and 246) may have holes in the bottom, so that grow solution provided to the trays flows through each successive tray in a stack and excess grow solution eventually travels through a given stack of trays and returns to the reservoir 234 through the open top side 236 due to gravity pulling the grow solution downward through the trays. As such, seeds that are in the trays of four stacks of trays (e.g., the stacks of trays 240 and 246) above the reservoir 234 may be exposed to grow solution at a desired schedule (e.g., by controlling the pump 224 and electronically controlled valves such as the valves 233 and 250) for a soaking and germination phase of the growing cycle of seeds. As such, the seeds in the first stage 200 as shown in FIG. 2 may be soaked and germinate to grow first roots while in the first stage 200 and the trays depicted in FIG. 2. The stacks of trays advantageously are tightly stacked, thereby requiring little overall space because the seeds inside the trays are still small and only a small amount of space between trays is needed as shown in FIG. 2 as the trays are at least partially nested within one another. In other words, each tray except a bottom tray of each stack of trays is configured to at least partially nest within a subsequent tray below each tray in the stack of trays.

A tray used with the fodder growing systems and methods herein, including in the stacks of trays depicted in FIG. 2, may be a 10 inch by 20 inch by 2 inch deep perforated tray, for example. Regardless of the size of tray, the removable rack 238 and the reservoir 234 as well as its open top side 236 may be sized to fit a desired number of stacks of trays over the reservoir 234. In various embodiments, a reservoir may be designed to have different numbers of stacks of trays situated over top of a reservoir and its open top side, such as anywhere from 1 stack to 20 stacks (e.g., 1 stack, 2 stacks, 4 stacks (as shown in FIGS. 2), 6 stacks, 8 stacks, 10 stacks, 12 stacks, 14 stacks, 16 stacks, 18 stacks, 20 stacks). Each of the stacks may also have varying numbers of trays as desired for a given embodiment, such as anywhere from 2 to 100 trays in a stack, including 2, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, or 100 trays in a stack.

In the first stage as depicted in FIG. 2, seeds may be spread in each tray dry. In various embodiments, seeds may also be placed in the trays that are wet or presoaked. After the seeds are placed in the trays, the trays are stacked directly together (e.g., so that the trays come into contact with one another). The trays may have no gaps in between them, may have some gap due to the seeds in the trays, may have a predefined gap based on an interference feature of the trays (e.g., so that the trays stack to intentionally leave a space between the bottom of the trays), etc. The stacks of trays may be placed in different locations over a reservoir, such as shown in the four locations above the open top side 236 of the reservoir 234 as shown in FIG. 2. As described herein, each stack of trays may have its own piping and a valve controlled by a timer and controller/processor of the computing device 202, such that each stack of trays may be flood soaked and drained many times per day during a predetermined time of a first stage of the fodder growing system. For example, each stack of trays may be flood soaked anywhere from 1 to 10 times per day (e.g., including 1, 2, 3, 4, 5, 6, 7, 8, 9, or 10 times) over a predetermined time that each tray or stack of trays is in the first stage 200. For example, the first stage 200 may last anywhere from 1 to 8 days (e.g., including 1, 2, 3, 4, 5, 6, 7, or 8 days). This cycling of watering allows time for the grow solution to pass through all the trays in a given stack. In various embodiments, such watering may also advantageously eliminate any need to presoak seed and germinate the seed before the seeds are placed in the trays.

As such, the first stage 200 of the fodder growing system includes the pump 224 that pumps grow solution from the reservoir 234 configured to hold grow solution through various piping to various stacks of trays (e.g., the stacks of trays 240 and 246) that rest over the open top side 236 of the reservoir 234. When the grow solution is pumped into a top tray of each stack, the grow solution works its way down through the stack of trays so that the grow solution drains not absorbed by the seeds or otherwise trapped int the trays drains back into the reservoir 234.

Although not shown in FIG. 2, a bubbler or other method of adding air or other components to the reservoir may be fluidly connectable to the reservoir to provide bubbles within the grow solution or water. For example, bubblers may help dissolve oxygen into water or a grow solution which may be beneficial to the seeds/plants in a fodder growing system. Hydrogen peroxide may also be added to the water or grow solution, which naturally oxidizes over time to output water and oxygen, which may also increase the amount of dissolved oxygen in the grow solution. The hydrogen peroxide may be added manually or using a pump (not shown in FIG. 2). For example, hydrogen peroxide may be added using a metering pump that adds a predetermined amount of hydrogen peroxide automatically to the reservoir 234 over a predetermined amount of time for a continuous supply of additional hydrogen peroxide. This may be beneficial since the hydrogen peroxide may break down to water and oxygen over time. The free floating oxygen molecules released by the hydrogen peroxide (or H₂O₂) may also advantageously kill single celled organisms like fungi, bacteria, etc. and may also add oxygen to the grow solution to aid in root growth of the fodder.

At the first stage, the reservoir 234 may also be periodically refilled after grow solution has been used up, after the reservoir 234 is cleaned, etc. A pipe or hose for refilling the reservoir 234 may be optionally equipped with an electric valve that automatically turns off with a float switch that causes the flow of grow solution to stop once the grow solution reaches a certain level or height within the reservoir 234.

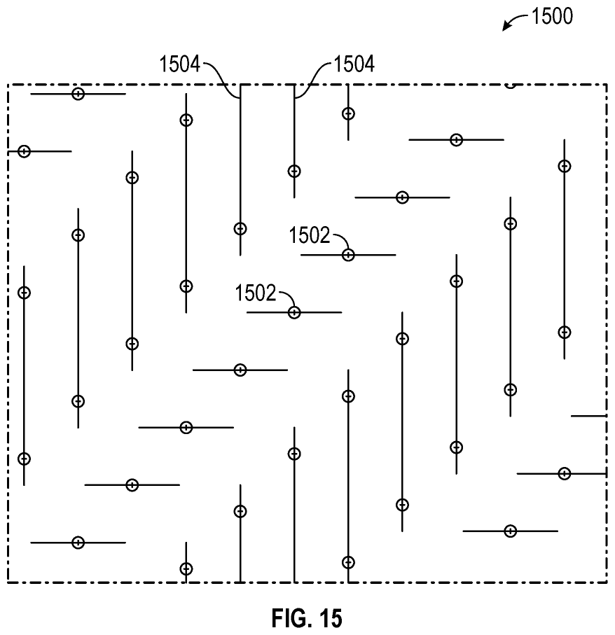

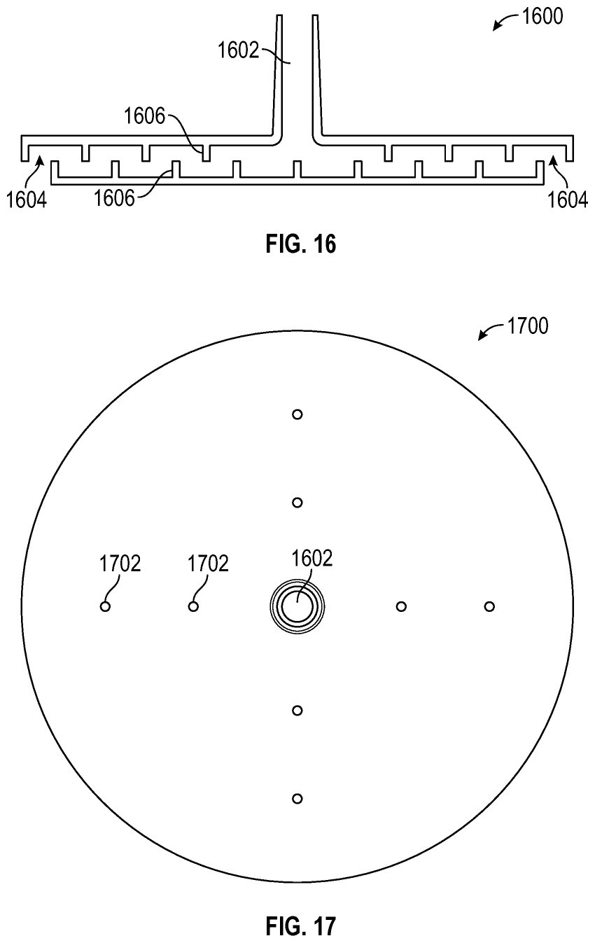

FIG. 3 is a perspective view of an example diffuser 300 in a fodder growing tray 308 in accordance with various embodiments. The diffuser 300 includes piping 304 that splits into two, and each end of the piping 304 is connected to further pipes 306 that each have two open ends. As such, grow solution pumped through piping 302 to the diffuser 300 exits out of four different ends of the pipes 306 to diffuse the grow solution being pumped into the tray 308 and thereby reduce the amount of seeds that may become bunched together by pressure of the grow solution, increase the number of seeds exposed to the grow solution, ensure the grow solution is diffused so that it drains evenly throughout the holes (not shown in FIG. 3) that in the bottom of tray 308, etc. Other diffusers of various configurations, such as those described below with respect to FIGS. 16 and 17, may also be used in various embodiments.

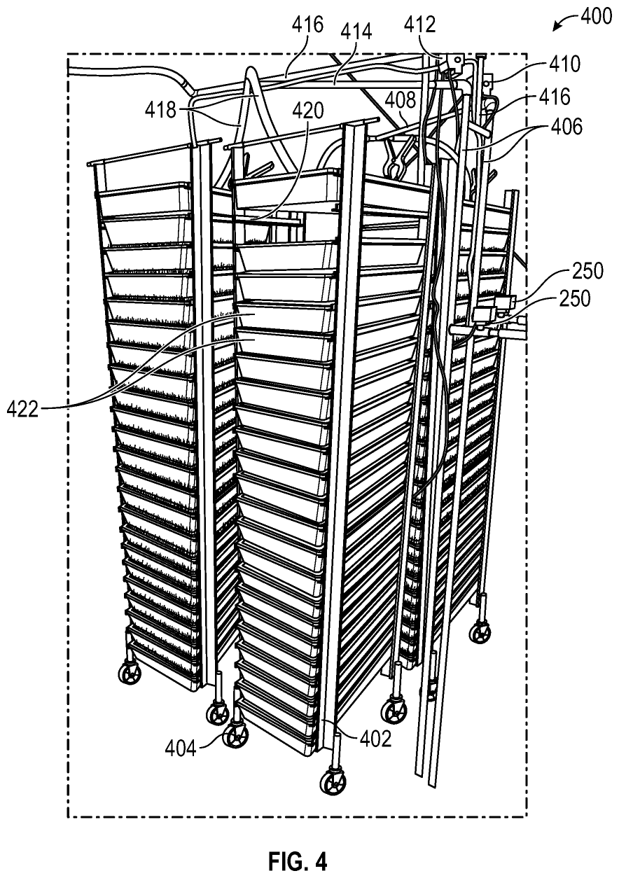

FIG. 4 is a perspective view of an example second stage 400 of a three stage fodder growing system in accordance with various embodiments. In the example of FIG. 4, the second stage 400 is made up of four towers that make up tray racks, including an example tray rack 402. The tray racks, including the tray rack 402, are designed to hold trays vertically. The tray racks may hold, for example, 20-25 trays. The trays may be spaced apart further than the trays were in the first stage to allow the seeds in the trays to sprout into seedlings having roots, stems, and/or leaves. As such, the trays may have a small amount of spacing between the top of a given tray and the bottom of subsequent tray in a tray rack. The spacing between the trays at the second stage 400 may be sufficient for forming seedlings from respective seeds in each of the trays in a given tray rack at the second stage 400.

In various embodiments, different tray racks may have trays loaded into them on different days, so that the tray racks are on different schedules for moving the trays from a given tray rack from the second stage 400 to a third stage (and then replacing those trays with new trays from a first stage and moving them to the second stage 400). In various embodiments, different numbers of tray racks may be used in the second stage 400 to correspond to a number of trays or stacks of trays that are used at a first stage. In various embodiments, the system may be configured such that a stack of trays (e.g., from the first stage 200 in FIG. 2) are all started on the same day and then moved to a tray rack of the second stage 400 on the same day.

The number of trays in the stack of trays may also correspond to the number of shelves 420 available in a tray rack of the second stage 400 so that once a stack of trays has completed the first stage it can fill an entire tray rack at stage two, and similarly that entire tray rack can complete stage two on the same day allowing all the trays in a given tray rack to be moved at the same time to a third stage as described further herein. For example, each tray rack of trays in the second stage may grow for four days, being watered at desired intervals each day during that predetermined amount of time of four days, as the seeds establish their roots and short sprouts (e.g., stems and/or leaves). This second stage may be completed without exposing the trays to grow lighting. Some lighting may incidentally be exposed to the trays, however, in various embodiments.

In FIG. 4, the tray rack 402 may include casters such as a caster 404 so that the tray rack 402 may be moved easily to load trays into the tray rack 402 from stage one or unload trays from the tray rack 402 into a tray rack of stage three (e.g., a greening rack as described herein). When the tray rack 402 does have trays loaded from stage one, one of the watering lines 418 may be placed in a top tray so that the tray rack may be watered and a drain line (not shown) may be placed at a bottom tray or otherwise under the tray rack to ensure proper drainage of the grow solution that passes through all the trays of the tray rack. The watering lines 418 are piping connected to a pipe 414 that runs to a valve 412 so that grow solution to the tray rack 402 may be controlled electronically as desired. In the embodiments shown in FIG. 4, the watering for two tray racks is controlled together with a single valve (e.g., one valve for every two tray racks). However, in various embodiments, other configurations may be used such as one valve for each tray rack, one valve for every four tray racks, etc. In FIG. 4, a valve 410 controls grow solution to the two tray racks on the far side of FIG. 4 that are partially or fully obstructed (e.g., the valve 410 controls grow solution that enters piping 408).

The piping 406 may be fluidly connected to piping of a first stage of a fodder growing system (e.g., the pipe 231) so that grow solution may be pumped from the first stage to the second stage. FIG. 4 shows the piping 406 terminating at the bottom of FIG. 4 for simplicity, but in practice the piping 406 may be fluidly connected to other piping such as the pipe 231 as described herein. The piping 406 may also be connected to piping 416 that supplies grow solution to a third stage of the fodder growing system (e.g. as shown in and described with respect to FIGS. 1, 5, and 6).

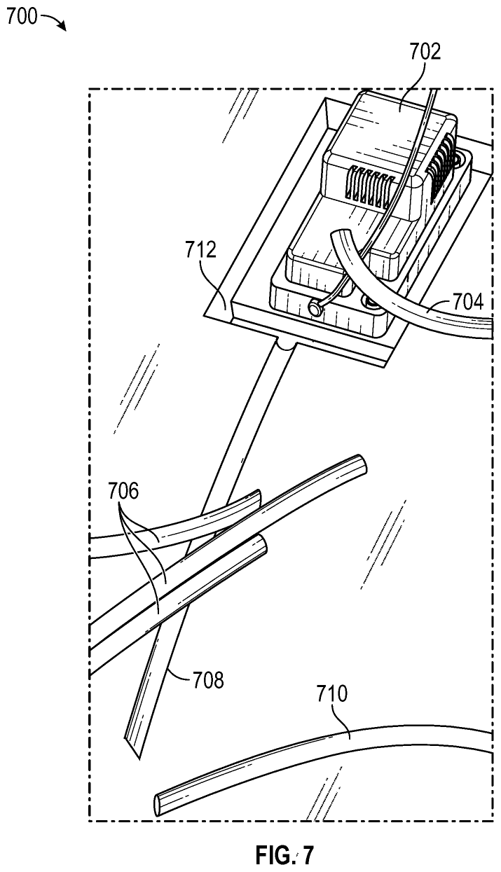

As such, the second stage includes one or more tray racks that have a plurality of shelves 420, each shelf 420 configured to receive one of a plurality of trays. Piping fluidly connects a reservoir of grow solution to an area at or above a top tray of a given tray rack, so that a pump may pump the grow solution from the reservoir to the area at or above the top of the given tray rack. That grow solution may be selectively electronically controlled by a computing device (e.g., the computing device 202 in FIG. 2) using electronically controlled valves, such that the pump moves grow solution selectively from the reservoir through piping and valves into a top tray of a given tray rack. The trays may further include holes in the bottom of each of the trays in the given tray rack, such that while the pump pumps the grow solution through the piping, at least some of the grow solution drains through the trays in the given tray rack and into a drain reservoir (e.g., as shown in and described further herein with respect to FIG. 7).

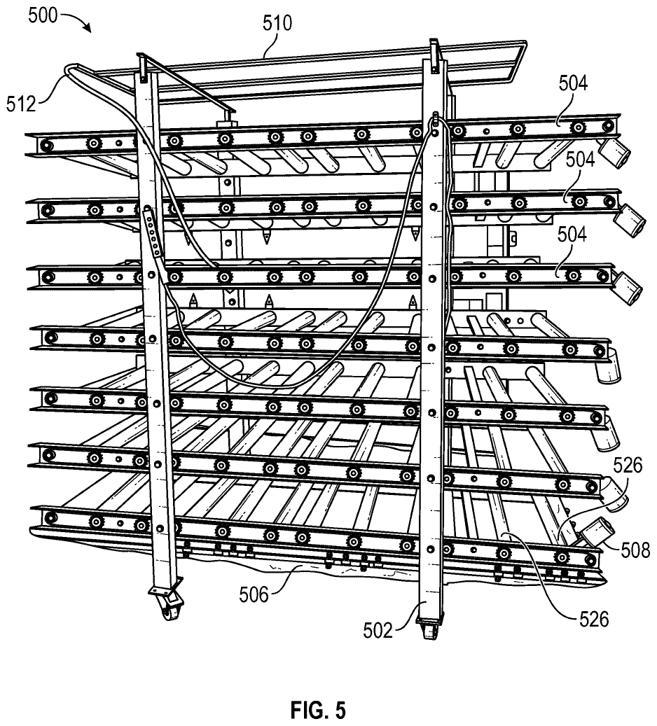

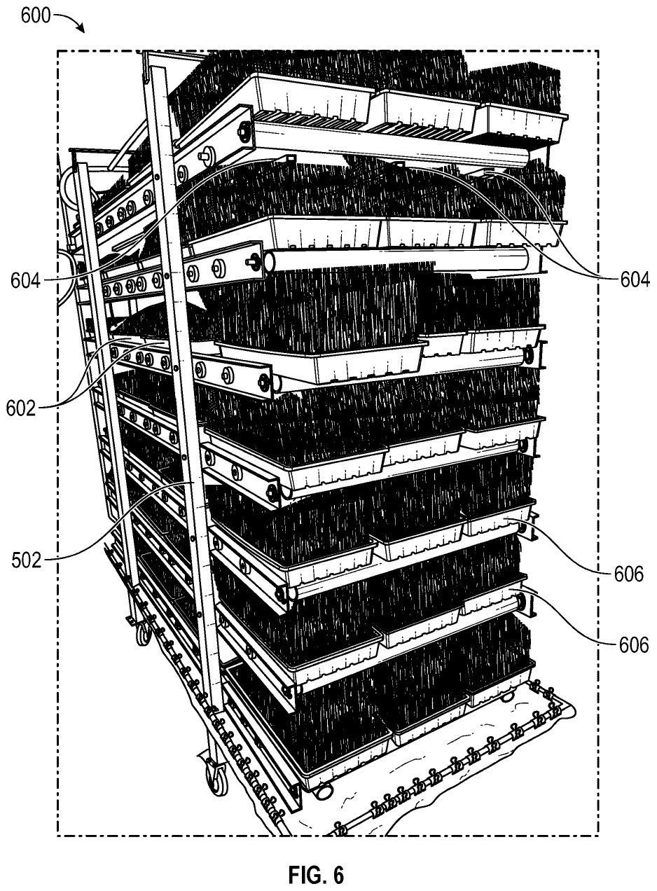

FIG. 5 is a perspective view of an example third stage 500 of a three stage fodder growing system in accordance with various embodiments. The third stage 500 in FIG. 5 has no trays loaded into it. FIG. 6 is a perspective view of an example third stage 600 of a three stage fodder growing system with grown fodder trays in accordance with various embodiments. In FIG. 5, shelves 504 are shown. The shelves 504 may be wider and longer than the shelves of the tray racks of the second stage, such that multiple trays may fit on a single shelf of the racks of the third stage. For example, FIG. 6 shows that three trays may fit side by side along a width or opening of a shelf and those rows of three trays may be four trays deep on each shelf of the tray rack 502. That is each of the shelves 504 may fit twelve trays in various embodiments. In other various embodiments, the shelves 504 or the trays may be sized to fit different numbers of trays on each shelf.

The tray rack 502 may be referred to as a greening rack. The tray rack 502 has greater spacing between the shelves 504 to allow for more vertical growth of the fodder as compared to spacing of the tray racks in the second stage 400 of FIG. 4. In other words, the spacing may be sufficient for maturing seedlings in each of the trays into grown fodder having a root system, stems, and/or leaves. The tray rack 502 also has a trickle-down watering system with grow solution runoff collection on the bottom, where a plastic or other type of sheet 506 is attached to a bottom of the tray rack 502. The sheet 506 may have a drain hole and pipe in the sheet 506 so that grow solution may be directed elsewhere after it has drained from the tray rack 502 (e.g., to the sump pump shown in and described further with respect to FIG. 7. The tray rack 502 has seven shelves high with room for three trays wide and 4 trays deep as described herein, while other configurations for numbers of shelves and capacity of those shelves may vary in other embodiments.

In various embodiments, the tray rack may also have electrical wires (e.g., as part of a 12 Volt electrical system, a 48 Volt system) to power grow lighting in the tray rack 502. The electrical system may further be connected to motors such as a motor 508 that may be connected to a chain that, upon operation of the motor 508, causes the chain to move and rollers 526 to turn so that trays loaded on the tray rack 502 can also move. The motor may be controlled manually or automatically as desired in various embodiments. In various embodiments, motors may not be used, and the rollers 526 may be free spinning so that when manually pushed or a tray is loaded on one end of the tray rack 502 that tray may advance other trays in the tray rack 502 by moving the trays across the rollers and further from the point at which the first tray is being loaded into a shelf of the tray rack 502. In other words, the shelves 504 may have rollers 526 that are configured to permit trays to roll or slide along a respective shelf of the shelves 504.

In various embodiments, the tray rack 502 is also on casters for mobility and cleaning. A grow solution line or pipe 512 may be connected to the first and/or second stage (e.g., to the pipe 416 in FIG. 4) to provide grow solution from the reservoir at a first stage of the fodder growing system via piping (e.g., the pipe 512 and the pipe 416). The grow solution reaching the third stage may be electrically controlled via a valve (not shown) fluidly connected to the pipe 512. A control wire may also be run from a computing device to any of the electronically controlled valves in a fodder growing system so that the computing device can control those valves to open or close.

As such, a pump may be configured to pump grow solution from a reservoir at a first stage through the piping 512 and into piping 510 that diffuses the grow solution around to all the trays on the top shelf of the tray rack 502. Each tray in the tray rack 502 will still have holes in the bottom of each of the trays, so that while the at least one pump pumps the grow solution through the piping 512 and 510, at least some of the grow solution drains through the trays in all the shelves 504 in the tray rack 502 and into the sheet 506 and ultimately into a drain reservoir (e.g., as shown in and described with respect to FIG. 7).

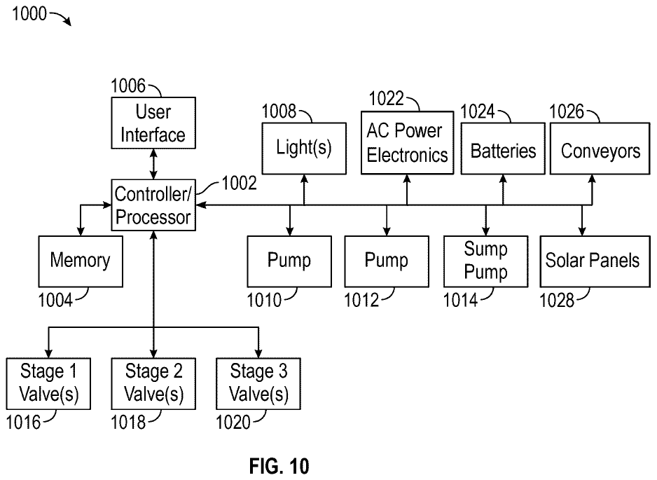

FIG. 6 further shows grow lighting 604 that may include a strip or string of light emitting diodes (LEDs). The grow lighting 604 may include these LED strings, three for each shelf, such that one string is positioned over each row of trays within the shelves of the tray rack 502. In other words, the grow lighting 604 is positioned above each of the second plurality of shelves and may also be over each tray upon those shelves. Although not shown in FIG. 6, the fodder growing system may also include one or more solar panels mounted outdoors (e.g., on a roof of a building containing the fodder growing system(s)), and the solar panels may be electrically connected to the grow lighting 604 to power the grow lighting 604, as further discussed herein with respect to FIG. 10. For example, the solar panels may generate direct current power, and the grow lighting 604 may be powered by direct current, and the solar panels may be directly or indirectly electrically connected to the grow lighting 604 source so that, for example, whenever the solar panels are generating the direct current power the grow lighting 604 may be powered with the direct current power. In various embodiments, the power from the solar panels may also be stored in a battery, converted to AC power for use by AC devices such as the pumps, filters, computing devices, etc. of a fodder growing system, directed to a power grid or otherwise used by the fodder growing system for various uses as desired. The grow lighting 604 may, in various embodiments, also be powered by AC power in addition to or instead of solar power. For example, if solar panels are not used or if solar power generated by solar panels is not sufficient, AC power may be used to provide power to the grow lighting 604 and/or to supplement the solar power provided to the grow lighting 604. Batteries charged using AC power and/or solar power from solar panels may additionally or alternatively be used to power the grow lighting 604 in various embodiments.

As further shown in FIG. 6, trays 606 in the foreground have more mature (longer/taller) fodder than trays 602 in the background. In various embodiments, trays from the second stage of the fodder growing system may be loaded onto the tray rack 502 in the background side of FIG. 6 into the shelves of the tray rack 504. In this way, the trays may be pushed through to the foreground side of FIG. 6 as they mature. In the example of FIG. 6, each tray may spend four days in the tray rack 502 growing. On the first day, a tray may be loaded into the background on a shelf, and moved one position each day as new trays are loaded into the tray rack 502 until they fodder is full grown and the given tray is removed on the foreground side of the tray rack 502 after the fourth day to make room for more trays to be loaded into the background side of the tray rack 502 that are coming from the second stage of the fodder growing system.

FIG. 7 is a perspective view of a sump pump 702 and grow solution drain for a fodder growing system in accordance with various embodiments. FIG. 7 shows a drain reservoir 712 that may collect excess grow solution from various stages of the fodder growing system. For example, pipes 704, 706, and/or 710 may come from tray racks of a second stage of a fodder growing system, tray racks of a third stage of a fodder growing system, etc. Those pipes 704, 706, and 710 may drain to a drain reservoir 712 so that the grow solution may be pumped back to a reservoir of a first stage of a fodder growing system by a sump pump to reuse that grow solution. The drain reservoir 712 may also be connected to one or more grooves, such as groove 708, in a surface (e.g., a floor) so that grow solution from the pipes 704, 706, 710 that does not flow directly into the drain reservoir 712 may be directed into the drain reservoir via the grooves like the groove 708 that may be cut into the surface or floor and angled to cause the grow solution to drain toward the drain reservoir 712 and the sump pump 702. The sump pump 702 may pump the excess drained grow solution back to a reservoir through piping (not shown) that fluidly connects the drain reservoir 712 and a reservoir of a first stage of a fodder growing system.

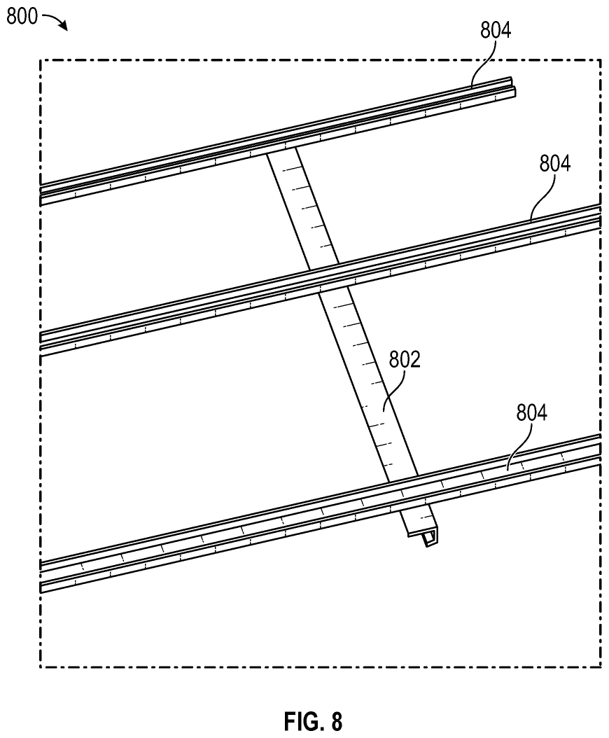

FIG. 8 is a partial perspective view of an example rack 800 for mounting grow lighting for a third stage of a fodder growing system in accordance with various embodiments. The rack 800 may be mounted under the shelves 504 of the tray rack 502 of FIGS. 5 and 6, for example. The rack 800 may have a cross-member 802 for supporting the u-shaped members 804. The members 804 may be u-shaped so that LED strips may be mounted inside the u-shape, and the members 802 of the rack 800 may be mounted on the underside of the shelves 504, causing the LED strips to shine grow lighting down toward a shelf below and the trays thereon a given shelf below. The u-shape of the members 804 may further prevent water or grow solution from getting on the LED strips mounted inside the u-shape of the members 804.

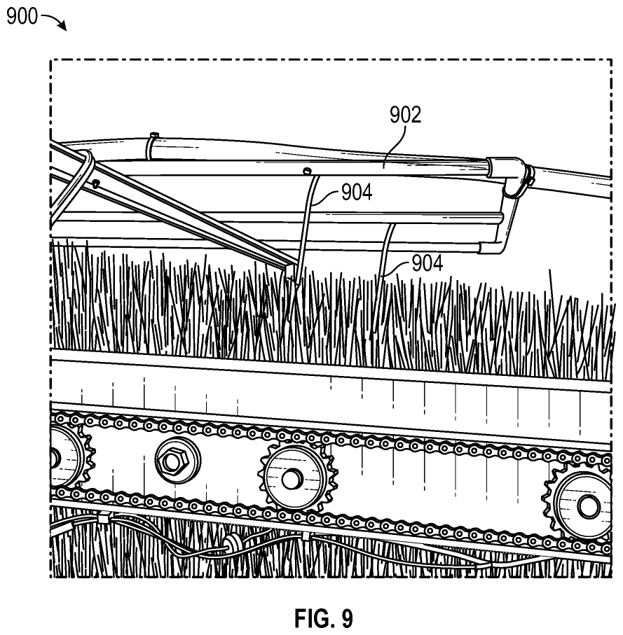

FIG. 9 is a partial perspective view 900 of an example portion of a third stage of a fodder growing system where the fodder is being watered in accordance with various embodiments. FIG. 9 particularly shows piping 902, which may be or may be similar to the piping 510 of FIG. 5, and how holes in the piping 902 may provide grow solution 904 to different trays on a top shelf of a tray rack of a third stage of a fodder growing system.

As such, FIGS. 1-9 have shown physical aspects of example fodder growing systems, where the natural growth of plant seeds is advantageously broken into to three stages, and separate equipment is used for each stage of growth development so that a high ratio of fodder growth relative to an amount of floor square footage is achieved compared to other systems. The system also reuses grow solution so that there is minimized, little, or no wastewater. Excess grow solution that passes through the trays is captured and returned to a treated reservoir so that it can be used again in the same fodder growing system. In addition, by only applying the grow lighting at the final or third stage of development the electrical usage and costs may be greatly reduced. The systems and methods herein may also provide additional nutrients to the grown plants after a seed has expended its own food supply. By using such hydroponic growing methods, the growth of the plant continues past the point where a seed has expended its own food supply, the plants can grow for longer (e.g., for barley seeds, 10-14 days of growth versus about 6 days without nutrient-rich grow solutions) to achieve a greater seed to feed ratio, which may also lower the feed cost to initially purchase seeds for the system.

The three stages are also easily movable on casters, detachable from one another, etc. so that the components of the stages can be easily moved or relocated for cleaning or any other purpose. Various setups may also have different numbers of tray racks and different capacities at different stages. For example, one setup may have four stage 2 towers, but with a slower growing seed like wheat, stage 2 could have more than four towers to lengthen the grow cycle additional days and such a configuration would not meaningfully increase the labor or electrical costs since there is no grow lighting applied at the second stage. The system may also, for example, be set up with one, two, or more of the stage 3 greening racks to lengthen the grow cycle. Each system may further have a computing device, such as a computer tablet at stage 1 or elsewhere, with a custom designed timer that allows for a nearly infinite number of watering variations for each stage or portion of a stage. The timer may be designed for multiple on and off cycles per day with adjustable on and off times displayed with countdown clock to the next cycle. This may reduce the amount of electricity required to pump water or grow solution to each stage or portion of a stage, since the pumping can be time varied throughout the day or over other predetermined amounts of time at desired/designated intervals.

FIG. 10 is a diagrammatic view of an example control system 1000 for a three stage fodder growing system in accordance with various embodiments. As described herein throughout, various aspects of a fodder growing system may be electronically controlled. As such, a computing device such as the computing device 202 of FIG. 2 may have or may act as a controller/processor 1002. The controller/processor 1002 may be in communication with a memory 1004 so that non-transitory, computer-readable instructions may be stored on the memory for execution by the controller/processor 1002. Those instructions may be modifiable by a user to customize how the various aspects of the system are controlled by the controller/processor 1002. A user may make such customizations, for example, via a user interface 1006, which may be a touch screen of a computing device (e.g., a tablet, smartphone). The controller/processor 1002 may further be in communication, via control wires, wirelessly, etc. with various components of the system, such as pumps 1010 and 1012, valves 1016, 1018, and 1020, and lights 1008 (including grow lighting), for the various stages of the fodder growing system as described herein, sump pump 1014, AC power electronics 1022, batteries 1024, conveyors 1026, and/or solar panels 1028.

The lights 1008 may be 12 Volt (V) direct current (DC) or 48 VDC, for example. The controller/processor 1002 may control when the lights 1008 are on or off an how the lights 1008 may be powered. For example, the controller/processor 1002 may control the lights to be powered by the solar panels 1028 that may be onsite, the batteries 1024 that may be onsite, or via system power of a building which may be controlled using AC power electronics 1022. The AC power electronics may include various components such as AC/DC converters, transformers, etc., which may be used to cause different aspects of a system to provide power to or use power from another aspect of the system, and may convert power between AC and DC power and between different voltages as needed for the given equipment/component of the system.

The solar panels 1028 for the lights 1008 may be wired in series to intentionally produce 48 VDC power, so that cables can be run form the solar panels 1028 to directly power the lights 1008. This may cause the lights 1008 to come on at dawn and go out at dusk just like in nature. As such, the lights 1008 may be powered and controlled without costly inverters and transformers that jay produce heat and loss of power. The solar panels 1028 may also be used to charge the batteries or power other components of the system.

The valves 1016, 1018, and 1020 are shown as three different components in FIG. 10, but each of the stages of a fodder growing system may include multiple valves as described herein. As such, there may be more than three valves (and more than one valve per stage) that may be separately controlled by the controller/processor 1002 according to instructions stored on the memory 1004.

The pumps 1010 and 1012 may be the pumps 222 and 224 of the first stage 200 depicted in FIG. 2, and as such the system may control when those pumps are running. The sump pump 1014 may be the sump pump 702 of FIG. 7, and the sump pump 702 may therefore be controlled by the controller/processor 1002. In various embodiments, the sump pump may have a sensor for automatically switching on whenever water or grow solution in a drain reservoir reaches a certain level to pump the water or grow solution back to a reservoir, such that outside control of the sump pump 702 by the controller/processor 1002 is not needed.

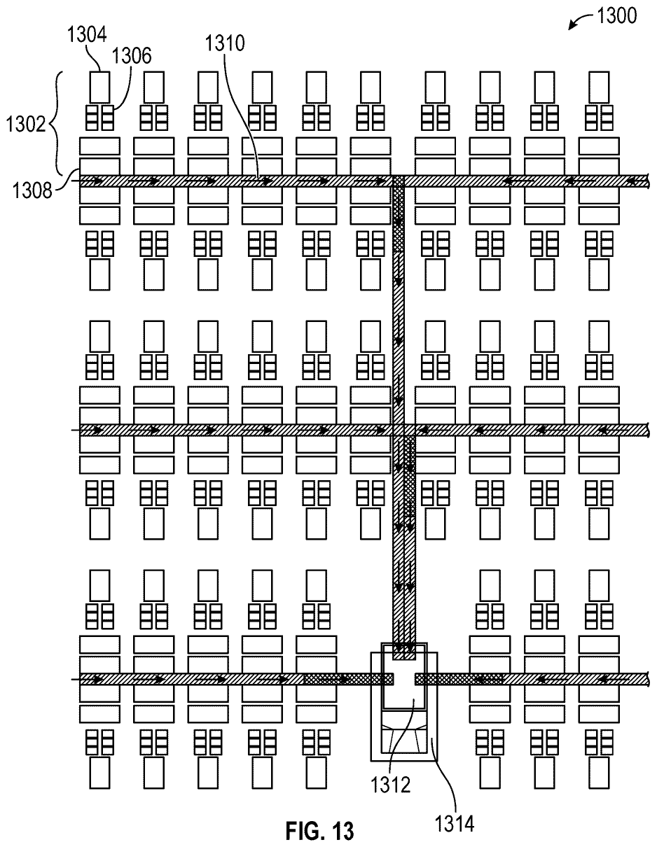

Conveyors 1026, such as the conveyors discussed further herein with respect to FIG. 13, may also be controlled by the controller/processor 1002. In other embodiments, the conveyors of FIG. 13 may be manually controlled whenever a truck is loading with fodder.

The conveyors 1026 may also additionally or alternatively be the motors that are shown in the third stage 500 of FIG. 5 that move trays in the third stage of a fodder growing system. As such, those motors may be automatically controlled by the controller/processor 1002 or in various embodiments may be manually controlled by a user with a button or other sort of control.

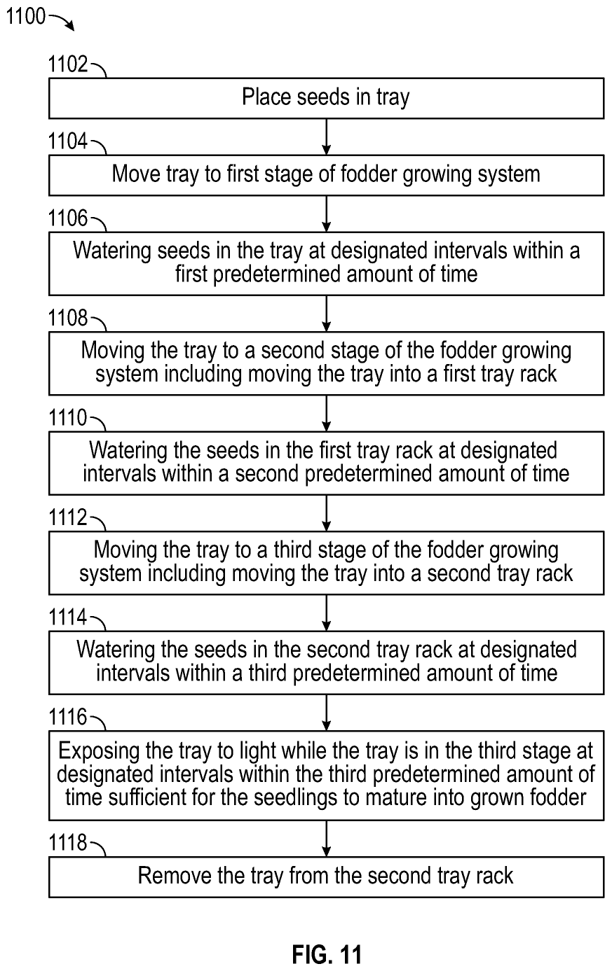

FIG. 11 is a flow chart illustrating an example method 1100 for using a three stage fodder growing system in accordance with various embodiments. At an operation 1102, seeds are placed in a tray. The seeds placed in the tray may be dry seeds. At an operation 1104, the tray is moved to a first stage of a fodder growing system that has a reservoir configured to hold a grow solution and the tray. The reservoir has an open top side and is configured to hold the tray over the open top side of the reservoir. The tray may be moved to the first stage after the seeds are placed in the tray or the seeds may be placed in the tray after the tray is moved to the first stage. The tray may also be placed on top of a second tray that is already at the first stage.

At an operation 1106, the seeds are watered in the tray with the grow solution at first designated intervals within a first predetermined amount of time (e.g., at a number of times per day (the designated intervals) for a certain number of days (the predetermined amount of time)) while the tray is at the first stage. The watering at the first stage may be sufficient for the seeds to absorb the grow solution and allow first roots to form. The tray may have holes in a bottom of the tray. During the watering of the seeds in the tray while the tray is at the first stage, the holes in the bottom of the first tray are configured to permit excess grow solution to drain from the tray into subsequent trays or into the reservoir. The tray may also at least partially nest within another tray in a stack of trays over the reservoir (e.g., after a first tray is placed on top of a second tray at the first stage). As described herein, the grow solution used in the watering of the seeds in the tray while the tray is at the first stage may be pumped from the reservoir and a pump that pumps the grow solution from the reservoir to the tray may be controlled by a computing device to water the tray at the first stage at the first designated intervals within the first predetermined amount of time.

At an operation 1108, the tray may be moved from the first stage to a second stage of the fodder growing system (e.g., after the predetermined amount of time or days has passed), and the moving the tray from the first stage to the second stage may include placing the tray in a first tray rack of the second stage.

At an operation 1110, the seeds may be watered with the same grow solution from the reservoir at the first stage while the trays are in the first tray rack at the second stage. The trays in the first tray rack may be watered at second designated intervals within a second predetermined amount of time (e.g., at a number of times per day (the designated intervals) for a certain number of days (the predetermined amount of time)) while the tray is in the second stage. The second predetermined amount of time (e.g., a number of days) may be sufficient for stems and first leaves to develop from the seeds thereby forming seedlings in the tray. The grow solution used in the watering of the tray in the first tray rack while the tray is in the second stage may be pumped from the reservoir and a pump that pumps the grow solution from the reservoir to the tray may be controlled by a computing device to water the tray at the second stage at the second designated intervals within the second predetermined amount of time.

In various embodiments, where there is more than one tray rack at the second stage, the tray racks may be generally left in a same position while seeds/seedlings in trays are growing, and may be moved/rolled over to a tray rack of the third stage once the trays in a given tray rack are ready to be transferred to the third stage. In various embodiments, the tray racks may also be moved within stage two into different positions corresponding with each day that the tray racks are in stage two. For example, if the trays spend four days in stage two and there are four tray racks in stage two, there may be four positions in stage two for the tray racks, one for each day, and the tray racks may be moved each day between the four positions so that it is easy to keep track of the tray racks that must be unloaded to stage three upon the completion of the four days. In such embodiments, the floor may be marked to show the position for the four tray racks and what day (e.g., 1, 2, 3, 4) each position is. In various embodiments, multiple tray racks may be used and generally kept in the same positions, but the trays may be moved between each of the stage two racks each day. In such embodiments, the tray racks may be marked with what day they are for the stage (e.g., 1, 2, 3, 4).

At an operation 1112, the tray is moved from the second stage to a third stage of the fodder growing system. The moving of the tray from the second stage to the third stage may include removing the tray from the first tray rack of the second stage and placing the tray in a second tray rack, which is part of the third stage. The first tray rack may have a first plurality of shelves configured to store a first plurality of trays, the second tray rack may have a second plurality of shelves configured to store a second plurality of trays, and a first spacing between each of the first plurality of shelves may be less than a second spacing between each of the second plurality of shelves. That first spacing may be sufficient for forming seedlings from respective seeds in each of the first plurality of trays, and the second spacing may be sufficient for maturing the seedlings in each of the second plurality of trays into grown fodder (e.g., greening the fodder into plants having stems and/or leaves).

A tray may need to be removed from the second tray rack prior to placing the first tray in the second tray rack. Placing the first tray in the second tray rack may further cause at least one tray to move within the second tray rack as described herein, as the second tray rack may include rollers built into the shelves of the second tray rack, so that the trays may move within the second tray rack along the rollers. In other words, the placing of one tray in the second tray rack may push other trays in the rack along the rollers as described herein. The various trays in the tray rack may also be directly, manually pushed by a user of the system as opposed to using one tray to push the other trays along within the rack.

At an operation 1014, the seedlings are watered, with the grow solution from the reservoir, in the tray in the second tray rack at third designated intervals within a third predetermined amount of time (e.g., at a number of times per day (the designated intervals) for a certain number of days (the predetermined amount of time)) while the tray is in the third stage. The grow solution used in the watering of the tray in the second tray rack while the tray is in the third stage may be pumped from the reservoir and a pump that pumps the grow solution from the reservoir to the tray may be controlled by a computing device to water the tray at the third stage at the third designated intervals within the third predetermined amount of time.

At an operation 1116, the seedlings in the second tray rack are exposed to light while the tray is in the third stage. The tray may remain in the third stage for the third predetermined amount of time, and the third predetermined amount of time may be sufficient for the seedlings to mature into grown fodder. The exposing of the seedlings in the second tray rack to the light may include applying grow lighting to the tray while the tray is in the second tray rack in the third stage as described herein. The grow lighting may not be applied to the tray while the tray is in the first tray rack in the second stage or while the tray is in the first stage.

At an operation 1118, the tray may be removed from the second tray rack upon completion of the third predetermined amount of time. During the third predetermined amount of time, the tray may be moved within the second tray rack along the rollers as additional trays are added to the second tray rack. As described herein, the tray may move each day as additional trays are added on a first side of the second tray rack, and the tray may eventually be removed after greening on the second tray rack for the third predetermined amount of time from a second side of the second tray rack opposite of the first side.

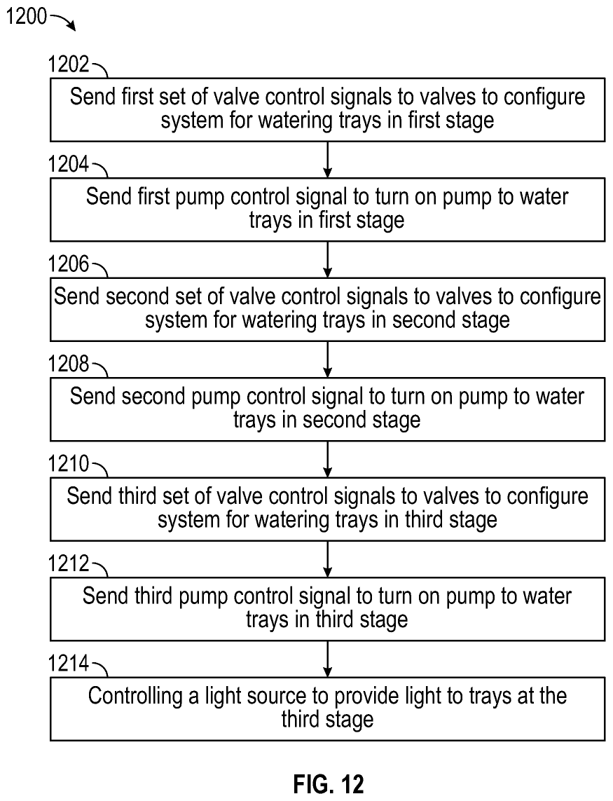

FIG. 12 is a flow chart illustrating an example method 1200 for electronically controlling a three stage fodder growing system in accordance with various embodiments.

For example, a controller or processor such as the controller/processor 1002 may send out control signals to various aspects of a system to control how and when different stages or portions of stages are watered as described herein. A non-transitory computer-readable medium (e.g., a memory) having instructions stored thereon may be used by a computing device having a processor or controller to execute that instructions and send out control signals as shown in and described with respect to the example method 1200 that, upon execution by the computing device, cause a system to perform some or all of the operations of the example method 1200.

At an operation 1202, a first set of valve control signals are sent to a set of valves, and the first set of valve control signals are configured to cause the set of valves to permit grow solution to be pumped through a piping system from a reservoir of a fodder growing system to a first tray at a first stage of the fodder growing system. At an operation 1204, after sending the first set of valve control signals, a first pump control signal is sent to a pump. The first pump control signal is configured to cause the pump to water seeds in the first tray at the first stage of the fodder growing system by way of various piping and one or more valves that are controlled to be open based on the first set of valve control signals.

At an operation 1206, a second set of valve control signals are sent and are configured to cause the set of valves to permit the grow solution to be pumped through the piping system from the reservoir to a second tray at a second stage of the fodder growing system. At an operation 1208, after sending the second set of valve control signals, sending a second pump control signal to the pump. The second pump control signal is configured to cause the pump to water the second tray at the second stage of the fodder growing system. The second pump control signal is configured to cause the pump to water seeds in the first tray at the second stage of the fodder growing system by way of various piping and one or more valves that are controlled to be open based on the second set of valve control signals.

At an operation 1210, a third set of valve control signals is sent and configured to cause the set of valves to permit the grow solution to be pumped through the piping system from the reservoir to a third tray at a third stage of the fodder growing system. At an operation 1212, after sending the third set of valve control signals, a third pump control signal is sent to the pump. The third pump control signal is configured to cause the pump to water the third tray at the third stage of the fodder growing system. The third pump control signal is configured to cause the pump to water seeds in the first tray at the third stage of the fodder growing system by way of various piping and one or more valves that are controlled to be open based on the third set of valve control signals.

The first set of valve control signals, the first pump control signal, the second set of valve control signals, the second pump control signal, the third set of valve control signals, and the third pump control signal are configured to be sent according to a predetermined schedule, wherein the predetermined scheduled defines designated intervals during a predetermined amount of time during which the first tray is watered at the first stage, the second tray is watered at the second stage, and the third tray is watered at the third stage. In various embodiments, for example, none of the first tray, the second tray, and the third tray may be watered at the same time. As described herein, the predetermined schedule may also be user definable via user inputs entered at a user interface of a computing device.

At an operation 1214, a light source may be controlled to provide light to the trays at the third stage of the fodder growing system. As described herein, the lighting may also be automatically controlled to provide light to the third stage whenever solar panels that are connected to the lights are outputting DC power. In such embodiments, the lighting may not be controlled using a controller/processor or instructions stored on a memory. In various embodiments, grow lighting may be controlled to automatically come on whenever solar panels they are connected to are outputting DC power and the grow lighting may be separately controlled by a controller/processor. Such embodiments may be useful, for example, where it is advantageous to turn on grow lighting during a cloudy day where not enough solar power is produced or to cause longer periods of the grow lighting to be on when the days are short during winter. In various embodiments, the control of the lighting with a controller/processor may also override solar panels outputting DC power. That is, the grow lighting may be turned on or off even while solar panels are outputting DC power. In such instances, the DC power output by the solar panels may be diverted to power other devices or to charge batteries, for example. As such, the controlling of the light source may include sending a lighting control signal configured to cause the light source to be powered by one of a battery power source, a building alternating current (AC) source, a solar panel direct current (DC) source, or a generator, in various embodiments.

In various embodiments, the lighting control signal may also sent to cause the light source to be powered according to a predetermined schedule, wherein the predetermined scheduled defines designated intervals during a predetermined amount of time during which grow lighting is provided to the third tray at the third stage. The predetermined schedule may also be user definable via user inputs entered at a user interface, such as the user interface of the computing device 202 of FIG. 2.

FIG. 13 is a diagrammatic view 1300 of an example floor plan and conveyer system for implementing a plurality of three stage fodder growing systems in accordance with various embodiments. A single fodder growing system 1302 may be duplicated many times throughout a building as shown in FIG. 13. For example, each fodder growing system in the building, as typified by the single fodder growing system 1302, may have a first stage 1304 (e.g., similar to the first stage of FIG. 2), a second stage 1306 (e.g., similar to the second stage of FIG. 4), and a third stage 1308 (e.g., similar to the third stage of FIGS. 5 and 6).

In an example embodiment using the setup of FIG. 13, the single fodder growing system 1302 may grow 42 trays of fodder each day, and the grow process for a single tray may take nine days. In order to grow fodder at this frequency, a first stage as shown in FIGS. 1 and 2 may be used that has four stacks of trays. Each stack of trays may have 21 trays, and each tray may be at stage 1 for two days. Two of the four trays may be started on a first day, and the second two of the four trays may be started on a second day. At the end of the second day, after the first two stacks of 21 trays have been at stage 1 for two days, those two stacks may be moved to stage 2. At that time a new two stacks of 42 trays (21 trays in each of the two stacks) may be started at stage 1. In this way, two stacks (42 trays) may be ready to move to stage 2 each day where two groups of two stacks of trays are used at stage 1 and each of the two groups of two stacks are started at stage 1 on alternating days.

When the two stacks of 42 trays are ready to move to the second stage after two days, each stack may fit in a tray rack of stage two, such as the tray racks shown in FIG. 4. In the example of FIG. 13, the second stage 1306 has six tray racks because each tray may spend three days in stage two. As such, when two stacks of trays are ready after two days in stage one, those two stacks may be moved to two respective tray racks of the second stage 1306. Each day thereafter, two stacks of trays from the first stage 1304 may be ready and moved to two other tray racks of the second stage 1306. Once two tray racks at the second stage 1306 have had trays in them for three days, the trays from those two racks may be moved to the two tray racks at the third stage 1308.

The two tray racks at the third stage 1308 may be the tray racks of FIGS. 5 and 6, and therefore may each hold 21 trays at a first position of the third stage tray racks (so the two tray racks of the third stage 1308 can hold 42 trays at a first position total). In another day, two more racks from the second stage will be ready and the trays from those second stage racks may be moved to the third stage racks, pushing the previous trays along in the third stage racks one position. As shown in FIG. 6, there may be 4 positions in the third stage racks, so that each tray may spend 4 days, 1 day at each of the four positions, in the third stage racks.

As such, once the process is up and running, a new 42 trays worth of seeds can be started at stage 1 every day, 42 trays worth of sprouted seeds can be moved from stage 1 to two racks of stage 2 every day, 42 trays worth of seedlings can be moved from stage 2 to the two racks of stage 3 every day, and 42 trays worth of mature fodder can be removed from stage 3 every day. In such a configuration, each tray will spend 9 days in the fodder growing system.

Once the matured fodder is removed from the third stage and the trays form which they were grown, the fodder makes up a single contiguous biscuit due to its root mass. The biscuits of fodder can be loaded onto conveyors 1310 that may move the fodder, for example, into a truck 1312 at a loading position in a building. In this way, large amounts of fodder may be produced each day and moved into trucks quickly. The position in the building at which the truck 1312 is parked may also be equipped with a certified truck scale 1314, which may be used to weigh the truck and provide a ticket for driver or rancher picking up the fodder. This ticket may be used, for example, for invoicing the driver or rancher picking the fodder so that the fodder can be paid for.

Although a nine day grow period has been described, various types of seeds may be grown in different times with different times at each stage. Based on the seeds and periods of growth and time at each stage, the number of trays used, tray racks used, etc. may be varied to achieve a desired output and timing of fodder growth.

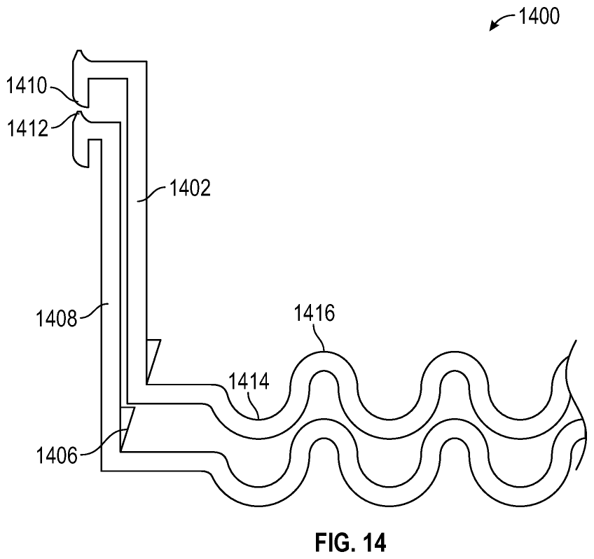

A customized tray with advantageous features may also be used in various embodiments. FIG. 14 is a cross-sectional partial front view 1400 of two stacked trays 1402 and 1408 for use in a fodder growing system in accordance with various embodiments. The trays 1402 and 1408 include a bump stop 1406 so that the top tray 1402 sits on the bump stop 1406 of the 1408. This is useful in the first stage where the trays are nested within one another. The bump stops will prevent the trays from nesting too far into one another and crushing seeds within the trays. The bump stop may be, for example three quarters of an inch high so that the trays have a three quarters of an inch gap between the top inside surface of the tray 1408 and the lower outside surface of the tray 1402. The trays also may have peaks 1416 and valleys 1414 in the bottom of the trays to make troughs for seeds to settle in and grow solution to drain through. Though not shown in FIG. 14, the trays will also have holes in the bottom for the grow solution to drain through.

An upper edge or lip of the trays may also have an upper point 1412 to try and prevent grow solution from spilling over the edge of the trays. The trays may also have a lower tapered edge 1410 so that any grow solution that overflows from the trays rounds inward toward the trays, such that surface tension in the grow solution will cause the grow solution to be pulled inward back toward the trays and drop into the next tray down. This may save grow solution and resources, reducing the waste and costs of operating the system. The upper point 1412 of the tray 1408 may further be located outside the lower tapered edge 1410 of the tray 1402 so that grow solution traveling down the tapered edge 1410 may more easily drop onto an inward side of the upper point 1412 and into the tray 1408. In various embodiments, the outer, vertical walls of trays (e.g., the trays 1402 and 1408) may be slightly angled outward from the center of the tray (e.g., the vertical walls and bottom of a tray may form an angle greater than a ninety degree or right angle) so that the trays more easily stack and/or nest within one another. In various embodiments, a top lip of the tray (e.g., the portion of the tray 1408 between its vertical wall and the upper point 1412) may also be angled downward away from the upper point 1412 (e.g., may not be parallel with the ground or a bottom of the tray) to further aid grow solution flowing from the upper point 1412 back into the tray 1408.

FIG. 15 is a partial top plan view of a bottom of a tray 1500 for use in a fodder growing system in accordance with various embodiments. FIG. 15 shows how the holes, peaks, and valleys may be configured in the bottom of an example tray for use in the fodder growing systems described herein. Holes 1502 may be drilled or placed along the lines 1504 in the bottom of trays, where the lines 1504 represent the valleys (e.g., similar to the valleys 1414 of FIG. 14) and the space between the lines 1504 represents the peaks (e.g., similar to the peaks 1416 of FIG. 14). The ends of the valleys 1504 are separated and some are at 90 degree angles with respect to one another so the valleys do not extend end-to-end in the bottom of the trays. The holes 1502 may be, for example, 3/16 of an inch or 7/32 of an inch wide. The valleys may be, for example, ¾ of an inch apart from one another, 1.5 inches apart from one another, etc. In various embodiments, any other dimensions or designs of trays may be used.

A diffuser is shown in FIG. 3, and may be used in the top trays of stages one and two of the fodder growing system, for example. However, other diffusers may also be used to pump grow solution into the trays without spraying grow solution over the sides. For example, FIG. 16 is a cross-sectional front view 1600 of an example diffuser in a fodder growing tray in accordance with various embodiments. FIG. 17 is a top plan view 1700 of the example diffuser of FIG. 16 in accordance with various embodiments. The diffuser in FIGS. 16 and 17 have an inlet 1602 that may be attached to a hose or piping so that grow solution may be pumped into the diffuser. The diffuser may have a top and bottom section that are held together with screws at points 1702. The top portion and the bottom portion may together have teeth 1606 that slow down and change the direction of water or grow solution as it flows from the inlet 1602 to the outlets 1604. Since the diffuser is circular, the single inlet 1602 may have grow solution that flows into the diffuser at a single point and the grow solution is then spread out across 360 degrees of outlet 1604 at the edge of the diffuser.

Similarly, the teeth 1606 appear straight in cross-section, but may be circular and extend throughout the diffuser, each one of the teeth 1606 having the shape of a circle within the circular diffuser of FIGS. 16 and 17. Such diffusers may slow down fast-flowing grow solution to keep it from spilling over the sides of trays, may help prevent clogging from seeds or other debris in dirty or grow solution, and may still provide enough back pressure to get water or grow solution to pass to the second, third, or other subsequent trays without clogging. The diffuser in FIGS. 16 and 17 may be, for example, 8 inches wide, which will easily fit into a 10 inch by 20 inch tray.

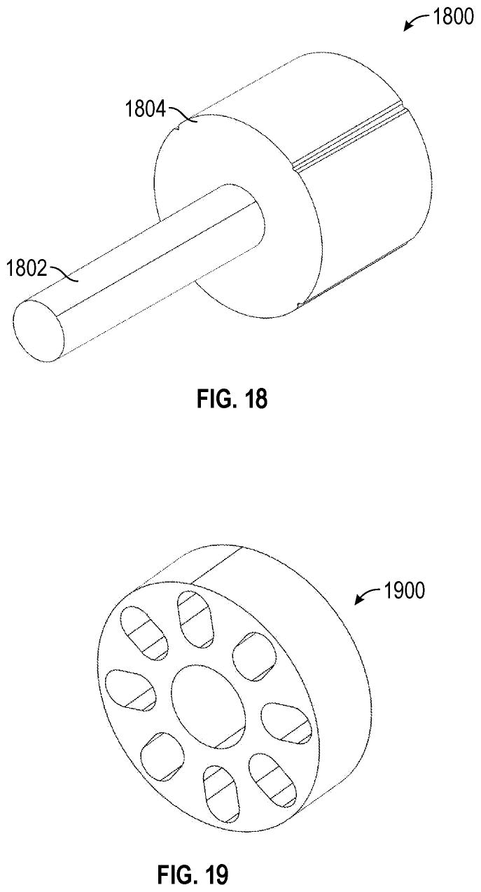

FIG. 18 is a perspective view of an axle 1800 for a roller of a tray rack of a third stage in accordance with various embodiments. FIG. 19 is a perspective view of a fitting 1900 for connecting to the axle of FIG. 18 in accordance with various embodiments. As described herein, rollers may be used in the tray racks of a third stage of a fodder growing system. In examples where the rollers are free spinning so that the trays can be pushed along the rollers, a roller may be constructed by rigidly attaching the axle 1800 to a hollow pipe, such as a polyvinyl chloride (PVC) water pipe, by affixing the wide portion 1804 to the inside of the PVC pipe used as the roller (on both ends of the water pipe). The PVC pipe may, for example, be a 1.5 inch PVC pipe. The fitting 1900 of FIG. 19 may be a bearing that screws onto a rail of the shelves of the tray racks of the third stage, and then a shaft 1802 of the axle 1800 can fit inside the center hole of the fitting 1900 and spin therein. Thus, the roller (including the axle 1800) can spin relative to the tray rack (including the fitting 1900).

In alternative embodiments like FIG. 5, where motors are used to move the trays, the axle 1800 may be rigidly affixed to both the roller and a fitting similar to that of FIG. 19, such as a sprocket. The sprocket may spin relative to the shelves of the tray rack so that a chain affixed to such a sprocket and moved by the motors can move the rollers and thereby move the trays sitting on the rollers.

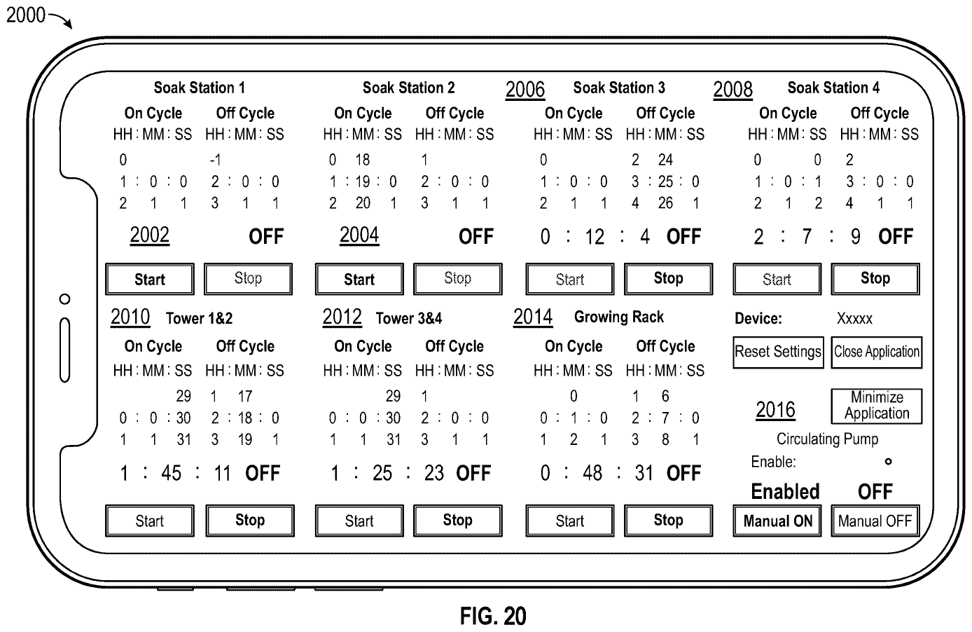

FIG. 20 is a diagrammatic view of an example user interface for a computing device 2000 for use with a fodder growing system in accordance with various embodiments. The example in FIG. 20 shows a computing device 2000 that may be a tablet computing device, though the device may be other types of computing devices in various embodiments. The user interface shown on the computing device 2000 may be shown on, for example, the computing device 202 of FIG. 2. The computing device 2000 may also be or be similar to the computing device 202. As such, the computing 2000 may be used to control the various components of a fodder growing system as described herein.

For example, the user interface on the computing device 2000 includes various portions 2002, 2004, 2006, 2008, 2010, 2012, 2014, and 2018 for controlling various aspects of a fodder growing system as described herein. For example, the portions 2002, 2004, 2006, and 2008 may each correspond to a single stack of trays at a first stage of a fodder growing system. On the user interface of FIG. 20, the first stage of the fodder growing system is referred to on the user interface as a soak station. As such, each stack of trays waterings may be separately controlled by the user interface using the portions 2002, 2004, 2006, and 2008. The waterings may be controlled manually using the start and stop buttons, or the timers may be set under the “on cycle” and “off cycle” sections to set one or more times of day in which the water to a certain stack of trays at the first stage is turned on and off. In this way, the user interface may be used to set multiple waterings for each stack of trays at the first station at designated times each day, and lasting a desired duration for each watering. While the user interface shows separate portions for each stack of trays at stage one or the soak station, in various embodiments multiple stacks of trays may be watered at the same time due to how the piping and valves are constructed and/or controlled. As such, the user interface may be configured in other embodiments such that more than one (e.g., 2, 4) or all of the stacks of trays at stage one are controlled using a single portion of the user interface as shown in FIG. 20.

Similarly to the portions 2002, 2004, 2006, and 2008 with respect to stage one, portions 2010 and 2012 may be used to control various aspects of a second stage of a fodder growing system. In the example of FIG. 20, two tray racks, also referred to as towers in the user interface of FIG. 20, may be controlled together by each of the portions 2010 and 2012. In other words, in the example of FIG. 20, the second stage of the fodder growing system may have four tray racks at stage two, and the portion 2010 may control the watering of a first pair of tray racks at stage two while the portion 2012 may control the watering of the remaining pair of tray racks at stage two. The pairs of tray racks may be controlled together, for example, where piping going into a pair of tray racks is controlled by a single valve. Similar to the portions 2002, 2004, 2006, and 2008, the watering may be manually controlled or may be controlled to be turned on and off at pre-programmed times of day by a user. In various embodiments, the portions 2010 and 2012 may be configured to control only watering of a single tray or may be configured to control watering of more than two trays as desired in various embodiments.

Portion 2014 may be used to control a grow rack, or tray rack, of a third stage of a fodder growing system. Similar to the other portions 2002, 2004, 2006, 2008, 2010, and 2012, the portion 2014 may be used to manually control watering at a third stage tray rack or may be pre-configured by a user to water the tray rack at the third stage at predetermined times and for predetermined durations for each watering. While the embodiment of FIG. 20 shows only a single portion 2014 for controlling watering of a tray rack at the third stage of a fodder growing system, various embodiments may have multiple tray racks at a third stage that are all controlled by a single portion of a user interface or may have multiple tray racks at a third stage that are each controlled by a separate portion of a user interface.

The user interface of FIG. 20 further includes a portion 2016. The portion 2016 may include a “manual on” and a “manual off” button for manually turning a grow solution circulation pump (e.g., the pump 224 of FIG. 2) on or off, respectively. The portion 2016 may also show when the circulating pump is on or off (e.g., operating or not operating). For example, where the portions 2002, 2004, 2006, 2008, 2010, 2012, and/or 2014 have been used to program times at which various components of a fodder growing system are watered, each watering may trigger the circulating pump to turn on and the valves of a system may be properly configured to water that portion of the system. Whenever the pump is on, an indicator that the pump is on may be displayed at the portion 2016. Similarly, each of the portions 2002, 2004, 2006, 2008, 2010, 2012, and/or 2014 may also indicate whether each section is being watered and/or if its associated valve is switched on/open. The portion 2016 may also have buttons for resetting the settings controlled by the user interface to a default, closing the application/user interface, or minimizing the application/user interface.

While FIG. 20 demonstrates one example embodiment for controlling one example setup of a fodder growing system, other embodiments of user interfaces may be used that are tailored to and/or configured for different setups of fodder growing systems as described herein. For example, in another example user interface, one or more of the portions 2002, 2004, 2006, 2008, 2010, 2012, and/or 2014 may be used for controlling a pump that adds hydrogen peroxide to a reservoir of the fodder growing system. For example, a first portion of the user interface may be set to add a relatively larger amount of hydrogen peroxide to the grow solution into the grow solution in the reservoir once a day (e.g., at the beginning of the day when new seeds are added in one or more new stacks of trays at stage one of the fodder growing system). This larger amount of added hydrogen peroxide that is added once per day may help kill mold spores or any other microbes that may be present on the new seeds in the new stacks of trays added at stage one. A second portion of the user interface may be used, for example, to control addition of a relatively smaller amount of hydrogen peroxide to the grow solution in the reservoir at more regular intervals throughout a day. This may, for example, help replenish the amount of hydrogen peroxide within the grow solution as the existing hydrogen peroxide in the grow solution naturally decomposes over time. For example, the larger amount of hydrogen peroxide added once a day and the smaller amount of hydrogen peroxide added regularly throughout the day may be at a ratio of anywhere from 50:1 to 500:1 (e.g., 50:1, 75:1, 100:1, 125:1, 150:1, 175:1, 200:1, 225:1, 250:1, 275:1, 300:1, 325:1, 350:1, 375:1, 400:1, 425:1, 450:1, 475:1, 500:1). As controlled by a timer and the user interface, the smaller amount of hydrogen peroxide may be added to the grow solution in the reservoir, for example, anywhere from once every minute to once every hour (e.g., every 1 minute, every 2 minutes, every 3 minutes, every 4 minutes, every 5 minutes, every 6 minutes, every 7 minutes, every 8 minutes, every 9 minutes, every 10 minutes, every 11 minutes, every 12 minutes, every 13 minutes, every 14 minutes, every 15 minutes, every 16 minutes, every 17 minutes, every 18 minutes, every 19 minutes, every 20 minutes, every 25 minutes, every 30 minutes, every 35 minutes, every 40 minutes, every 45 minutes, every 50 minutes, every 55 minutes, every 60 minutes). In such an embodiment where two portions of the user interface are used for controlling two different schedules for adding hydrogen peroxide, the user interface may further combine certain aspects to be controlled on a same potion as compared to FIG. 20. For example, the “soak station(s)” 1 and 2 controlled by the portions 2002 and 2004 may be combined to be controlled by a single portion of the user interface and the “soak station(s)” 3 and 4 controlled by the portions 2006 and 2008 may be combined to be controlled by a single portion of the user interface. In this way, two of the portions of the user interface shown in FIG. 20 may be freed up to be used for controlling two different schedules and amounts for adding hydrogen peroxide to the reservoir (e.g., one timer/portion for controlling the larger addition of hydrogen peroxide once a day and one timer/portion for controlling the relatively smaller addition of hydrogen peroxide multiple times per day).

In various embodiments, microgreens for human consumption or fodder for animals may be grown. In embodiments where microgreens for human consumption are grown, the trays may be lined with cheesecloth or another membrane to prevent smaller seeds from be washed through holes in the bottom of trays. In various embodiments, the holes in the trays may also be smaller or of a size that prevents seeds from passing from tray to tray during watering.

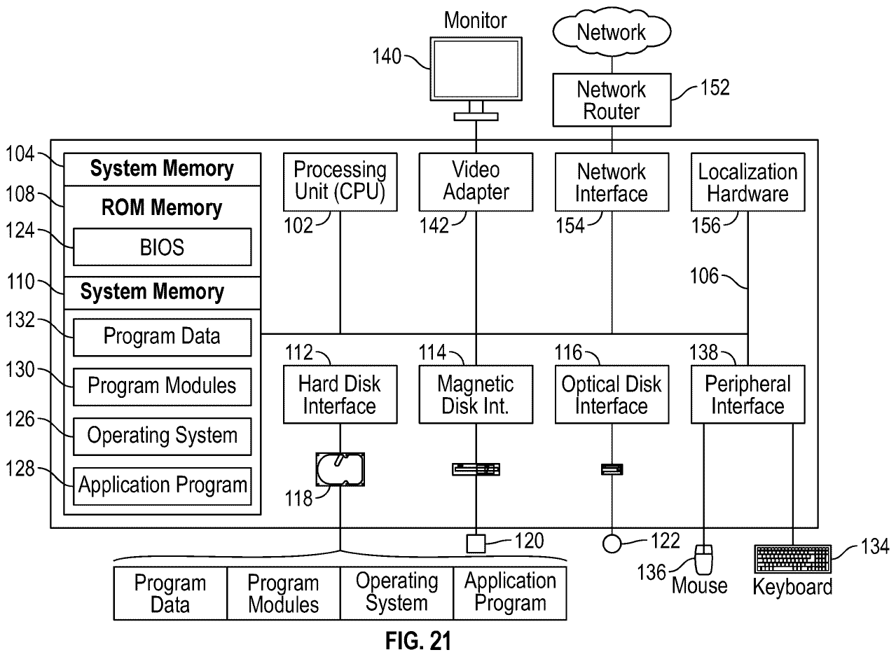

FIG. 21 is a diagrammatic view of an example of a computing environment that includes a general-purpose computing system environment 100, such as a desktop computer, laptop, smartphone, tablet, or any other such device having the ability to execute instructions, such as those stored within a non-transient, computer-readable medium. Various computing devices as disclosed herein (e.g., the computing device 202, the controller/processor 1002, the memory 1004, the user interface 1006, or any other computing device used in various embodiments or in communication with the computing devices described herein) may be similar to the computing system 100 or may include some components of the computing system 100. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100. Various methods described herein may be implemented with such a computing system 100 or various components of the computing system 100, including the control of pumps, valves, bubblers, lighting, power systems, solar panels, batteries, AC power components, conveyers, etc. These components may be controlled based on predetermined schedules, such as schedules set by a user with a user interface of the computing system 100 (e.g., the user interface of FIG. 20). Various portions of the methods 1100 or 1200 as described herein may further be fully or partially implemented or controlled using the computing system 100 or aspects of the computing system 100.

In its most basic configuration, computing system environment 100 typically includes at least one processing unit 102 and at least one memory 104, which may be linked via a bus 106. Depending on the exact configuration and type of computing system environment, memory 104 may be volatile (such as RAM 110), non-volatile (such as ROM 108, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 112, a magnetic disk drive interface 114, and/or an optical disk drive interface 116. As will be understood, these devices, which would be linked to the system bus 306, respectively, allow for reading from and writing to a hard disk 118, reading from or writing to a removable magnetic disk 120, and/or for reading from or writing to a removable optical disk 122, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 124, containing the basic routines that help to transfer information between elements within the computing system environment 100, such as during start-up, may be stored in ROM 108. Similarly, RAM 110, hard drive 118, and/or peripheral memory devices may be used to store computer executable instructions including an operating system 126, one or more applications programs 128 (which may include the functionality disclosed herein, for example), other program modules 130, and/or program data 122. Still further, computer-executable instructions may be downloaded to the computing environment 100 as needed, for example, via a network connection.

An end-user may enter commands and information into the computing system environment 100 through input devices such as a keyboard 134 and/or a pointing device 136. While not illustrated, other input devices may include a microphone, a joystick, a game pad, a scanner, etc. These and other input devices would typically be connected to the processing unit 102 by means of a peripheral interface 138 which, in turn, would be coupled to bus 106. Input devices may be directly or indirectly connected to processor 102 via interfaces such as, for example, a parallel port, game port, firewire, or a universal serial bus (USB). To view information from the computing system environment 100, a monitor 140 or other type of display device may also be connected to bus 106 via an interface, such as via video adapter 132. In addition to the monitor 140, the computing system environment 100 may also include other peripheral output devices, not shown, such as speakers and printers.

The computing system environment 100 may also utilize logical connections to one or more computing system environments. Communications between the computing system environment 100 and the remote computing system environment may be exchanged via a further processing device, such a network router 152, that is responsible for network routing. Communications with the network router 152 may be performed via a network interface component 154. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the computing system environment 100.

The computing system environment 100 may also include localization hardware 186 for determining a location of the computing system environment 100. In some instances, the localization hardware 156 may include, for example only, a GPS antenna, an RFID chip or reader, a WiFi antenna, or other computing hardware that may be used to capture or transmit signals that may be used to determine the location of the computing system environment 100.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A method of growing fodder comprising:
(a) placing seeds in a tray;
(b) moving the tray to a first stage of a fodder growing system comprising a reservoir configured to hold a grow solution and the tray, wherein the reservoir comprises an open top side and is configured to hold the tray over the open top side of the reservoir;
(c) watering the seeds in the tray with the grow solution at first designated intervals within a first predetermined amount of time while the tray is at the first stage, wherein the watering at the first stage is sufficient for the seeds to absorb the grow solution and allow first roots to form;
(d) moving the tray from the first stage to a second stage of the fodder growing system, wherein the moving the tray from the first stage to the second stage comprises placing the tray in a first tray rack;
(e) watering the seeds, with the grow solution from the reservoir, in the tray in the first tray rack at second designated intervals within a second predetermined amount of time while the tray is in the second stage, wherein the second predetermined amount of time is sufficient for stems and first leaves to develop from the seeds thereby forming seedlings;
(f) moving the tray from the second stage to a third stage of the fodder growing system, wherein the moving the tray from the second stage to the third stage comprises placing the tray in a second tray rack;
(g)watering the seedlings, with the grow solution from the reservoir, in the tray in the second tray rack at third designated intervals within a third predetermined amount of time while the tray is in the third stage;
(h) exposing the seedlings in the second tray rack to light while the tray is in the third stage, wherein the tray remains in the third stage for the third predetermined amount of time sufficient for the seedlings to mature into grown fodder; and
(i) removing the tray from the second tray rack upon completion of the third predetermined amount of time.

2. The method of claim 1, wherein the first tray rack comprises a first plurality of shelves configured to store a first plurality of trays, the second tray rack comprises a second plurality of shelves configured to store a second plurality of trays, and a first spacing between each of the first plurality of shelves is less than a second spacing between each of the second plurality of shelves.

3. The method of claim 2, wherein the first spacing is sufficient for forming seedlings from respective seeds in each of the first plurality of trays.

4. The method of claim 3, wherein the second spacing is sufficient for maturing the seedlings in each of the second plurality of trays into grown fodder.

5. The method of claim 1, wherein at least one of the first tray rack or the second tray rack comprises casters mounted to a bottom of the at least one of the first tray rack or the second tray rack.

6. The method of claim 1, wherein the tray is moved to the first stage after the seeds are placed in the tray.

7. The method of claim 1, wherein the seeds are placed in the tray after the tray is moved to the first stage.

8. The method of claim 1, wherein the tray is a first tray, and wherein the moving of the first tray to the first stage comprises placing the first tray on top of a second tray.

9. The method of claim 8, wherein the first tray comprises holes in a bottom of the first tray.

10. The method of claim 9, wherein, during the watering of the seeds in the tray while the tray is at the first stage, the holes in the bottom of the first tray are configured to permit excess grow solution to drain from the first tray into the second tray.

11. The method of claim 8, wherein the first tray at least partially nests within the second tray after the first tray is placed on top of the second tray.

12. The method of claim 1, wherein, during the watering of the seeds in the tray while the tray is at the first stage, excess grow solution drains from the tray to the reservoir.

13. The method of claim 12, wherein the excess grow solution drains through holes in a bottom of the tray.

14. The method of claim 12, wherein the grow solution used in the watering of the seeds in the tray while the tray is at the first stage is pumped from the reservoir and a pump that pumps the grow solution from the reservoir to the tray is controlled by a computing device to water the tray at the first stage at the first designated intervals within the first predetermined amount of time.

15. The method of claim 12, wherein the grow solution used in the watering of the tray in the first tray rack while the tray is in the second stage is pumped from the reservoir and a pump that pumps the grow solution from the reservoir to the tray is controlled by a computing device to water the tray at the second stage at the second designated intervals within the second predetermined amount of time.

16. The method of claim 12, wherein the grow solution used in the watering of the tray in the second tray rack while the tray is in the third stage is pumped from the reservoir and a pump that pumps the grow solution from the reservoir to the tray is controlled by a computing device to water the tray at the third stage at the third designated intervals within the third predetermined amount of time.

17. The method of claim 1, wherein the seeds placed in the tray are dry seeds.

18. The method of claim 1, wherein the tray is a first tray, and wherein the method further comprises removing a second tray from the second tray rack prior to placing the first tray in the second tray rack.

19. The method of claim 18, wherein placing the first tray in the second tray rack causes at least one third tray to move within the second tray rack.

20. The method of claim 19, wherein the second tray rack comprises rollers built into the shelves of the second tray rack, and wherein the at least one third tray moves within the second tray rack along the rollers.

21. The method of claim 20, wherein the placing of the first tray in the second tray rack pushes the at least one third tray along the rollers.

22. The method of claim 1, wherein the exposing of the seedlings in the second tray rack to the light comprises applying grow lighting to the tray while the tray is in the second tray rack in the third stage.

23. The method of claim 22, wherein grow lighting is not applied to the tray while the tray is in the first tray rack in the second stage or while the tray is in the first stage.

24. A system for growing fodder comprising:
at least one pump;
a first stage comprising:
a reservoir configured to hold grow solution, wherein:
the reservoir comprises an open top side, and
a stack of trays configured to rest over the open top side of the reservoir; and
first piping fluidly connecting the reservoir to an area at or above the open top side of the reservoir, wherein while the stack of trays is placed over the open top side of the reservoir, the at least one pump is configured to pump the grow solution from the reservoir into a top tray of the stack of trays;
a second stage comprising:
a first tray rack comprising a first plurality of shelves, each of the first plurality of shelves configured to receive one of a plurality of trays; and
second piping fluidly connecting the reservoir to an area at or above a top of the first tray rack, wherein the at least one pump is configured to pump the grow solution from the reservoir to the area at or above the top of the first tray rack; and
a third stage comprising:
a second tray rack comprising a second plurality of shelves, each of the second plurality of shelves configured to receive one or more of the plurality of trays;
third piping fluidly connecting the reservoir to an area at or above a top of the second tray rack, wherein the at least one pump is configured to pump the grow solution from the reservoir to the area at or above the top of the second tray rack; and
at least one light source positioned above each of the second plurality of shelves.

25. The system of claim 24, wherein a plurality of stacks of trays is configured to rest over the open top side of the reservoir.

26. The system of claim 25, wherein the at least one pump is configured to pump the grow solution from the reservoir into a top tray of each of the plurality of stack of trays.

27. The system of claim 24, wherein each of the trays in the stack of trays comprises holes in the bottom of each of the trays, wherein while the stack of trays is placed over the open top side of the reservoir and the at least one pump pumps the grow solution through the first piping, at least some of the grow solution drains through the stack of trays through the holes and back into the reservoir.

28. The system of claim 24, wherein each tray except a bottom tray of the stack of trays is configured to at least partially nest within a subsequent tray below each tray in the stack of trays.

29. The system of claim 24, wherein the at least one pump is configured to pump the grow solution from the reservoir through the second piping and into a top tray in the first tray rack.

30. The system of claim 29, wherein each tray in the first tray rack comprises holes in the bottom of each of the trays in the first tray rack, and wherein while the at least one pump pumps the grow solution through the second piping, at least some of the grow solution drains through the trays in the first tray rack and into a drain reservoir.

31. The system of claim 30, further comprising a sump pump configured to pump the grow solution from the drain reservoir into the reservoir via fourth piping.

32. The system of claim 24, wherein the at least one pump is configured to pump the grow solution from the reservoir through the third piping and into a top tray in the second tray rack.

33. The system of claim 32, wherein each tray in the second tray rack comprises holes in the bottom of each of the trays in the second tray rack, and wherein while the at least one pump pumps the grow solution through the third piping, at least some of the grow solution drains through the trays in the second tray rack and into a drain reservoir.

34. The system of claim 33, further comprising a sump pump configured to pump the grow solution from the drain reservoir into the reservoir via fourth piping.

35. The system of claim 24, wherein each of the second plurality of shelves are configured to receive more than one tray of the plurality of trays.

36. The system of claim 35, wherein each of the second plurality of shelves comprises rollers configured to permit the more than one tray of the plurality of trays to roll or slide along a respective shelf of the second plurality of shelves.

37. The system of claim 24, wherein at least one of the reservoir, the first tray rack, or the second tray rack comprises casters mounted thereon.

38. The system of claim 24, further comprising valves in fluid connection with one or more of the first piping, the second piping, or the third piping, wherein the valves are controllable to cause the at least one pump to selectively pump the grow solution through only one or two of, but not all of, the first piping, second piping, or third piping at a time.

39. The system of claim 24, wherein the at least one light source comprises at least one string of light emitting diodes (LEDs).

40. The system of claim 24, further comprising at least one solar panel configured to power the at least one light source.

41. The system of claim 40, wherein the at least one solar panel generates direct current power, wherein the at least one light source is powered by direct current, and wherein the at least one solar panel is electrically connected to the at least one light source so that whenever the at least one solar panel is generating the direct current power the at least one light source is powered with the direct current power.

42. The system of claim 24, wherein the grow solution comprises water.

43. The system of claim 42, wherein the grow solution further comprises hydrogen peroxide.

44. The system of claim 42, wherein the grow solution comprises plant fertilizer.

45. The system of claim 42, wherein the grow solution comprises at least one mineral.

46. The system of claim 24, wherein a first spacing between each of the first plurality of shelves is less than a second spacing between each of the second plurality of shelves.

47. The system of claim 46, wherein the first spacing is sufficient for forming seedlings from respective seeds in each of the first plurality of trays.

48. The system of claim 47, wherein the second spacing is sufficient for maturing the seedlings in each of the second plurality of trays into grown fodder.

49. A non-transitory computer-readable medium having instructions stored thereon that, upon execution by a computing device, cause a system to perform operations comprising:
sending a first set of valve control signals configured to cause a set of valves to permit grow solution to be pumped through a piping system from a reservoir of a fodder growing system to a first tray at a first stage of the fodder growing system;
after sending the first set of valve control signals, sending a first pump control signal to a pump, wherein the first pump control signal is configured to cause the pump to water seeds in the first tray at the first stage of the fodder growing system;
sending a second set of valve control signals configured to cause the set of valves to permit the grow solution to be pumped through the piping system from the reservoir to a second tray at a second stage of the fodder growing system;
after sending the second set of valve control signals, sending a second pump control signal to the pump, wherein the second pump control signal is configured to cause the pump to water the second tray at the second stage of the fodder growing system;
sending a third set of valve control signals configured to cause the set of valves to permit the grow solution to be pumped through the piping system from the reservoir to a third tray at a third stage of the fodder growing system; and
after sending the third set of valve control signals, sending a third pump control signal to the pump, wherein the third pump control signal is configured to cause the pump to water the third tray at the third stage of the fodder growing system.

50. The non-transitory computer-readable medium of claim 49, wherein the first set of valve control signals, the first pump control signal, the second set of valve control signals, the second pump control signal, the third set of valve control signals, and the third pump control signal are configured to be sent according to a predetermined schedule, wherein the predetermined scheduled defines designated intervals during a predetermined amount of time during which the first tray is watered at the first stage, the second tray is watered at the second stage, and the third tray is watered at the third stage.

51. The non-transitory computer-readable medium of claim 50, wherein none of the first tray, the second tray, and the third tray are watered at the same time.

52. The non-transitory computer-readable medium of claim 50, wherein the predetermined schedule is user definable via user inputs entered at a user interface.

53. The non-transitory computer-readable medium of claim 49, wherein the instructions further cause the system to perform operations comprising controlling a light source to provide light to the third tray at the third stage.

54. The non-transitory computer-readable medium of claim 53, wherein the controlling of the light source comprises sending a lighting control signal configured to cause the light source to be powered by one of a battery power source, a building alternating current (AC) source, a solar panel direct current (DC) source, or a generator.

55. The non-transitory computer-readable medium of claim 54, wherein the lighting control signal is sent to cause the light source to be powered according to a predetermined schedule, wherein the predetermined scheduled defines designated intervals during a predetermined amount of time during which grow lighting is provided to the third tray at the third stage.

56. The non-transitory computer-readable medium of claim 55, wherein the predetermined schedule is user definable via user inputs entered at a user interface.
